(19) United States
(12) Patent Application Publication
(10) Pub. No.: US 2024/0318597 A1
(43) Pub. Date: Sep. 26, 2024

(54) COMBUSTOR SIZE RATING FOR A GAS TURBINE ENGINE USING HYDROGEN FUEL

(71) Applicant: General Electric Company, Schenectady, NY (US)

(72) Inventors: Michael A. Benjamin, Cincinnati, OH (US); Manampathy G. Giridharan, Mason, OH (US)

(21) Appl. No.: 18/736,667

(22) Filed: Jun. 7, 2024

Related U.S. Application Data
(63) Continuation-in-part of application No. 17/457,559, filed on Dec. 3, 2021.

(51) Int. Cl. F02C 7/22; F23R 3/28

(52) U.S. Cl. CPC F02C 7/22; F23R 3/28

(57) ABSTRACT

A gas turbine engine includes a hydrogen fuel delivery assembly configured to deliver a hydrogen fuel flow, a compressor section configured to compress air flowing therethrough to provide a compressed air flow, and a combustor including a combustion chamber having a burner length and a burner dome height. The combustion chamber is configured to combust a mixture of the hydrogen fuel flow and the compressed air flow. The combustion chamber can be characterized by a combustor size rating between one inch and seven inches. In more detail, the combustion chamber can be characterized by the combustor size rating between one inch and seven inches at a core air flow parameter between two and one half kN and sixty kN, in which the combustor size rating is a function of the core air flow parameter.

### CROSS-REFERENCE TO RELATED APPLICATION(S)

This application is a continuation-in-part of U.S. application Ser. No. 17/457,559, filed Dec. 3, 2021, now allowed, which is incorporated herein by reference in its entirety.

### TECHNICAL FIELD

The present disclosure relates to a combustor for a gas turbine engine using hydrogen fuel, and in particular, for a gas turbine engine for aircraft.

### BACKGROUND

The propulsion system for commercial aircraft typically includes one or more aircraft engines, such as turbofan jet engines. The aircraft engine(s) may be mounted to a respective one of the wings of the aircraft, such as in a suspended position beneath the wing using a pylon. These engines may be powered by aviation turbine fuel, which is typically a combustible hydrocarbon liquid fuel, such as a kerosene-type fuel, having a desired carbon number and carbon to hydrogen ratio. Such fuel produces carbon dioxide emissions upon combustion and improvements to reduce such carbon dioxide emissions in commercial aircraft are desired.

### BRIEF DESCRIPTION OF THE DRAWINGS

Features and advantages of the present disclosure will be apparent from the following, more particular, description of various exemplary embodiments, as illustrated in the accompanying drawings, wherein like reference numbers generally indicate identical, functionally similar, and/or structurally similar elements.

FIG. 1 is a schematic perspective view of an aircraft having a gas turbine engine according to an embodiment of the present disclosure.

FIG. 2 is a schematic, cross-sectional view, taken along line 2-2 in FIG. 1, of the gas turbine engine of the aircraft shown in FIG. 1.

FIG. 3 is a perspective view of an unducted single fan engine that may be used with the aircraft shown in FIG. 1.

FIG. 4 is a schematic, cross-sectional view, taken along line 4-4 in FIG. 3, of the unducted single fan engine shown in FIG. 3.

FIG. 5 is a schematic, cross-sectional view, taken along line 2-2 in FIG. 1, of a turbojet engine that may be used with the aircraft shown in FIG. 1.

FIG. 6 is a cross-sectional view of a first combustor for the gas turbine engine shown in FIG. 2, showing detail 6 of FIG. 2.

FIG. 7 is a cross-sectional view of a second combustor for the gas turbine engine shown in FIG. 2, showing detail 6 of FIG. 2.

FIG. 8 is a cross-sectional view of a third combustor for the gas turbine engine shown in FIG. 2, showing detail 6 of FIG. 2.

FIG. 9 is a cross-sectional view of a fourth combustor for the gas turbine engine shown in FIG. 2, showing detail 6 of FIG. 2.

FIG. 10 is a cross-sectional view of a fifth combustor for the gas turbine engine shown in FIG. 2, showing detail 6 of FIG. 2.

FIG. 11 is a graph illustrating combustor length (squared) as a function of combustor height, according to embodiments of the present disclosure.

FIG. 12 is a graph illustrating combustor size rating as a function of core air flow parameter in engine gas turbine engines using hydrogen fuel, according to embodiments of the present disclosure.

FIG. 13 is a schematic of a gas turbine engine.

FIG. 14 depicts a cross-section view along line XIV-XIV of FIG. 13 of a combustion section of the gas turbine engine.

FIG. 15 is a cross-sectional view of a combustor in the combustion section formed from a combustor liner having multiple sets of dilution openings, according to embodiments of the present disclosure.

FIG. 16 is a schematic of a variation of a portion XIV having a first set of dilution openings for the combustor from FIG. 15, according to embodiments of the present disclosure.

FIG. 17 is a variation of the first set of dilution openings from FIG. 15, according to embodiments of the present disclosure.

FIG. 18 is a variation of a portion of FIG. 17, according to embodiments of the present disclosure.

FIG. 19 is another variation of a portion of FIG. 17, according to another aspect of the disclosure herein.

FIG. 20 is a schematic of a variation of a portion XVI from FIG. 15 with a first set of dilution openings, according to embodiments of the present disclosure.

FIG. 21 is a schematic of a variation of the portion XVI from FIG. 15 with a first set of dilution openings according to another aspect of the disclosure herein.

FIG. 22 is a schematic of a variation of the portion XVI from FIG. 15 with a first set of dilution openings, according to embodiments of the present disclosure.

FIG. 23 is a schematic of a variation of the first set of dilution openings from FIG. 22, also located in the region XVI of FIG. 15, according to another aspect of the disclosure herein.

FIG. 24 is a schematic of a variation of the portion XVI from FIG. 15 with a first set of dilution openings according to yet another aspect of the disclosure herein.

FIG. 25 is a schematic of a variation a portion XVII of FIG. 15 with a flare cone and a dome wall, according to embodiments of the present disclosure.

FIG. 26 is a schematic of a variation the portion XVII of FIG. 15 with a flare cone and a dome wall according to another aspect of the disclosure herein.

FIG. 27 a variation of a portion of the cross-section view from FIG. 14 according to another aspect of the disclosure herein.

FIG. 28 is a schematic of a variation of the combustion section from FIG. 14 illustrating an arrangement of dome walls about the engine centerline.

FIGS. 29-33 are a first, second, third, fourth, and fifth exemplary distributions for any of the first set of dilution openings described herein located within the dome walls as arranged in FIG. 28.

### DETAILED DESCRIPTION

Features, advantages, and embodiments of the present disclosure are set forth or apparent from a consideration of the following detailed description, drawings, and claims. Moreover, it is to be understood that the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” “second,” and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a one, two, four, ten, fifteen, or twenty percent margin in either individual values, range(s) of values and/or endpoints defining range(s) of values.

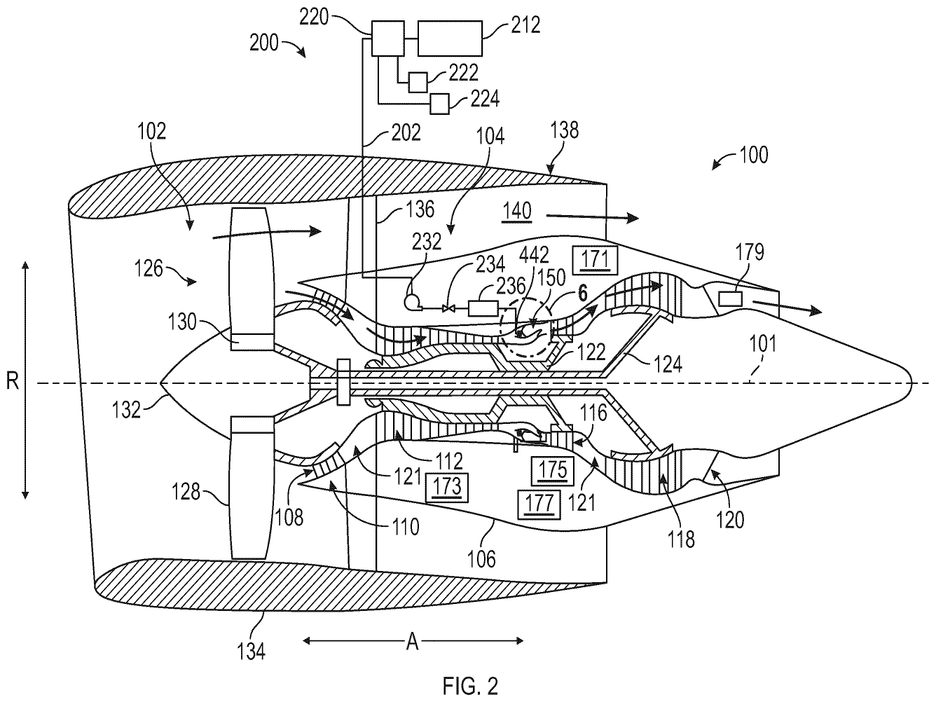

The term “bypass ratio,” unless stated otherwise, means the bypass ratio at take off conditions. The term bypass ratio as used herein means the ratio between the mass flow rate of air flow accelerated by the engine that bypasses the engine core to the mass flow rate of the air flow entering the engine core. For example, in an exemplary engine such as the turbofan engine 100 depicted in FIG. 2 and discussed further below, the bypass ratio is the ratio of the mass flow rate of the air flow entering the bypass air flow passage 140 to the mass flow rate of the air flow entering the core air flow path 121. The bypass ratio can also be estimated as a ratio of the area of an inlet to the bypass duct (e.g., inlet of the bypass air flow passage 140, discussed below) or an area swept by a rotor (e.g., the area swept by fan blades 322, discussed below) to the area of the inlet to the engine core (e.g., inlet of the core air flow path 121).

The term “thrust,” unless stated otherwise, means the maximum thrust at take off. This meaning of thrust is adopted when computing a core airflow parameter (relationship (2), below).

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other. Combustible hydrocarbon liquid fuel, such as Jet-A fuel, has long been used in

gas turbine engines and the components of gas turbine engines, particularly, the combustor, have been designed for such fuels. A hydrogen fuel may be utilized to eliminate carbon dioxide emissions from commercial aircraft. Hydrogen fuel, however, poses a number of challenges as compared to combustible hydrocarbon liquid fuel, such as Jet-A fuel. Hydrogen fuel, for example, is a highly reactive fuel that burns at higher temperatures than combustible hydrocarbon liquid fuel. Hydrogen fuel also has much higher flame speeds. For example, the laminar flame speed for a hydrogen fuel of diatomic hydrogen is an order of magnitude greater than the laminar flame speed for Jet-A fuel.

When testing hydrogen fuel in current gas turbine engines with rich burn combustors, we, the inventors, observed that the higher combustion temperature of hydrogen fuel results in increased production of nitrogen oxides (“NOx”), as compared to combustible hydrocarbon liquid fuel. We also observed in our testing that NOx emissions are sensitive to combustor residence time. As noted above, hydrogen fuel is highly reactive (relative to other fuels) with a wide range of flammability limits and very high flame speeds, resulting in a very short hydrogen flame close to the front end of the combustor. With such a short flame, the post-flame residence time increases for combustors designed for Jet-A fuel. These findings resulted in a realization that when designing a hydrogen fuel combustor to meet NOx emission targets, the combustor residence time needs to be reduced by more than about fifty percent. To find a suitable combustor design for gas turbine engines using hydrogen fuel, we conceived of a wide variety of combustors having different shapes and sizes in order to determine which embodiment(s) were most promising for a variety of contemplated engine designs and thrust classes. The various embodiments, as described herein and as shown in the figures, are combustors that are sized to meet NOx emissions targets.

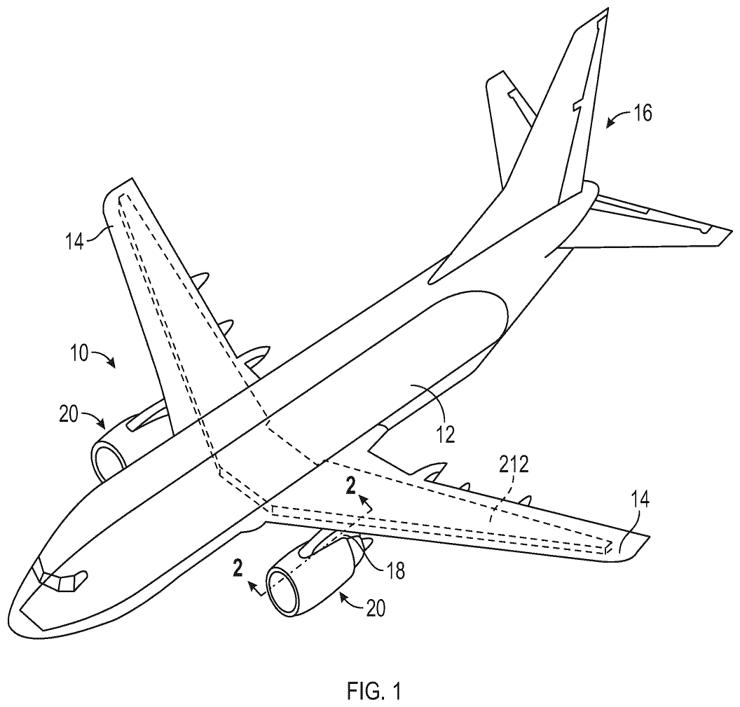

FIG. 1 is a perspective view of an aircraft 10 that may implement various preferred embodiments. The aircraft 10 includes a fuselage 12, wings 14 attached to the fuselage 12, and an empennage 16. The aircraft 10 also includes a propulsion system that produces a propulsive thrust required to propel the aircraft 10 in flight, during taxiing operations, and the like. The propulsion system for the aircraft 10 shown in FIG. 1 includes a pair of engines 20. In this embodiment, each engine 20 is attached to one of the wings 14 by a pylon 18 in an under-wing configuration. Although the engines 20 are shown attached to the wing 14 in an under-wing configuration in FIG. 1, in other embodiments, the engine 20 may have alternative configurations and be coupled to other portions of the aircraft 10. For example, the engine 20 may additionally or alternatively include one or more aspects coupled to other parts of the aircraft 10, such as, for example, the empennage 16 and the fuselage 12.

As will be described further below with reference to FIG. 2, the engines 20 shown in FIG. 1 are gas turbine engines that are each capable of selectively generating a propulsive thrust for the aircraft 10. The amount of propulsive thrust may be controlled at least in part based on a volume of fuel provided to the gas turbine engines 20 via a fuel system 200. The fuel is stored in a fuel tank 212 of the fuel system 200. As shown in FIG. 1, at least a portion of the fuel tank 212 is located in each wing 14 and a portion of the fuel tank 212 is located in the fuselage 12 between the wings 14. The fuel tank 212, however, may be located at other suitable locations in the fuselage 12 or the wing 14. The fuel tank 212 may also be located entirely within the fuselage 12 or the wing 14. The fuel tank 212 may also be separate tanks instead of a single, unitary body, such as, for example, two tanks each located within a corresponding wing 14.

Although the aircraft 10 shown in FIG. 1 is an airplane, the embodiments described herein may also be applicable to other aircraft 10, including, for example, helicopters and unmanned aerial vehicles (UAV). The aircraft discussed herein are fixed-wing aircraft or rotor aircraft that generate lift by aerodynamic forces acting on, for example, a fixed wing (e.g., wing 14) or a rotary wing (e.g., rotor of a helicopter), and are heavier-than-air aircraft, as opposed to lighter-than-air aircraft (such as a dirigible). The engine 20 may be used in various other applications including stationary power generation systems and other vehicles beyond the aircraft 10 explicitly described herein, such as boats, ships, cars, trucks, and the like.

FIG. 2 is a schematic, cross-sectional view of one of the engines 20 used in the propulsion system for the aircraft 10 shown in FIG. 1. The cross-sectional view of FIG. 2 is taken along line 2-2 in FIG. 1. For the embodiment depicted in FIG. 2, the engine 20 is a high bypass turbofan engine that is referred to as a turbofan engine 100 herein. The turbofan engine 100 has an axial direction A (extending parallel to a longitudinal centerline axis 101, shown for reference in FIG. 2), a radial direction R, and a circumferential direction. The circumferential direction (not depicted in FIG. 2) extends in a direction rotating about the axial direction A. The turbofan engine 100 includes a fan section 102 and a turbomachine 104 disposed downstream from the fan section 102.

The turbomachine 104 depicted in FIG. 2 includes a tubular outer housing or nacelle 106 and an inlet 108. Within the housing 106 there is an engine core, which includes, in a serial flow relationship, a compressor section including a booster or low-pressure (LP) compressor 110 and a high-pressure (HP) compressor 112, a combustion section 150 (also referred to herein as a combustor 150), a turbine section including a high-pressure (HP) turbine 116 and a low-pressure (LP) turbine 118, and a jet exhaust nozzle section 120. The compressor section, the combustor 150, and the turbine section together define at least in part a core air flow path 121 extending from the inlet 108 to the jet exhaust nozzle section 120. The turbofan engine 100 further includes one or more drive shafts. More specifically, the turbofan engine includes a high-pressure (HP) shaft or spool 122 drivingly connecting the HP turbine 116 to the HP compressor 112, and a low-pressure (LP) shaft or spool 124 drivingly connecting the LP turbine 118 to the LP compressor 110.

The fan section 102 shown in FIG. 2 includes a fan 126 having a plurality of fan blades 128 coupled to a disk 130. The fan blades 128 and the disk 130 are rotatable, together, about the longitudinal centerline axis 101 by the LP shaft 124. The booster 108 may also be directly driven by the LP shaft 124, as depicted in FIG. 2. The disk 130 is covered by a rotatable front hub 132 aerodynamically contoured to promote an air flow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially spaced outlet guide vanes 136. A downstream section 138 of the nacelle 134 extends over an outer portion of the turbomachine 104 so as to define a bypass air flow passage 140 therebetween.

The turbofan engine 100 is operable with the fuel system 200 and receives a flow of fuel from the fuel system 200. As will be described further below, the fuel system 200 includes a fuel delivery assembly 202 providing the fuel flow from the fuel tank 212 to the turbofan engine 100, and, more specifically, to a plurality of fuel nozzles 442 that inject fuel into a combustion chamber 430 of the combustor 150.

The turbofan engine 100 also includes various accessory systems to aid in the operation of the turbofan engine 100 and/or an aircraft including the turbofan engine 100. For example, the turbofan engine 100 may include a main lubrication system 171, a compressor cooling air (CCA) system 173, an active thermal clearance control (ATCC) system 175, and a generator lubrication system 177, each of which is depicted schematically in FIG. 2. The main lubrication system 171 is configured to provide a lubricant to, for example, various bearings and gear meshes in the compressor section, the turbine section, the HP spool 122, and the LP shaft 124. The lubricant provided by the main lubrication system 171 may increase the useful life of such components and may remove a certain amount of heat from such components through the use of one or more heat exchangers. The compressor cooling air (CCA) system 173 provides air from one or both of the HP compressor 112 or LP compressor 110 to one or both of the HP turbine 116 or LP turbine 118. The active thermal clearance control (ATCC) system 175 acts to minimize a clearance between tips of turbine blades and casing walls as casing temperatures vary during a flight mission. The generator lubrication system 177 provides lubrication to an electronic generator (not shown), as well as cooling/heat removal for the electronic generator. The electronic generator may provide electrical power to, for example, a startup electrical motor for the turbofan engine 100 and/or various other electronic components of the turbofan engine 100 and/or an aircraft including the turbofan engine 100.

Heat from these accessory systems 171, 173, 175, and 177, and other accessory systems, may be provided to various heat sinks as waste heat from the turbofan engine 100 during operation, such as to various vaporizers 220, as discussed below. Additionally, the turbofan engine 100 may include one or more heat exchangers 179 within, for example, the turbine section or jet exhaust nozzle section 120 for extracting waste heat from an air flow therethrough to also provide heat to various heat sinks, such as the vaporizers 220, discussed below.

The fuel system 200 of this embodiment is configured to store the fuel for the turbofan engine 100 in the fuel tank 212 and to deliver the fuel to the turbofan engine 100 via the fuel delivery assembly 202. The fuel delivery assembly 202 includes tubes, pipes, and the like, to fluidly connect the various components of the fuel system 200 to the turbofan engine 100. As discussed above, the turbofan engine 100, and, in particular, the combustor 150 discussed herein may be particularly suited for use with hydrogen fuel (diatomic hydrogen). In the embodiments shown in FIG. 2, the fuel is a hydrogen fuel comprising hydrogen, more specifically, diatomic hydrogen. In some embodiments, the hydrogen fuel may consist essentially of hydrogen.

The fuel tank 212 may be configured to hold the hydrogen fuel at least partially in the liquid phase and may be configured to provide hydrogen fuel to the fuel delivery assembly 202 substantially completely in the liquid phase, such as completely in the liquid phase. For example, the fuel tank 212 may have a fixed volume and contain a volume of the hydrogen fuel in the liquid phase (liquid hydrogen fuel). As the fuel tank 212 provides hydrogen fuel to the fuel delivery assembly 202 substantially completely in the liquid phase, the volume of the liquid hydrogen fuel in the fuel tank 212 decreases and the remaining volume in the fuel tank 212 is made up by, for example, hydrogen in the gaseous phase (gaseous hydrogen). As used herein, the term “substantially completely” as used to describe a phase of the hydrogen fuel, refers to at least 99% by mass of the described portion of the hydrogen fuel being in the stated phase, such as at least 97.5%, such as at least 95%, such as at least 92.5%, such as at least 90%, such as at least 85%, or such as at least 75% by mass of the described portion of the hydrogen fuel being in the stated phase.

To store the hydrogen fuel substantially completely in the liquid phase, the hydrogen fuel is stored in the fuel tank 212 at very low (cryogenic) temperatures. For example, the hydrogen fuel may be stored in the fuel tank 212 at about −253 degrees Celsius or less at atmospheric pressure, or at other temperatures and pressures to maintain the hydrogen fuel substantially in the liquid phase. The fuel tank 212 may be made from known materials such as titanium, Inconel®, aluminum, or composite materials. The fuel tank 212 and the fuel system 200 may include a variety of supporting structures and components to facilitate storing the hydrogen fuel in such a manner.

The liquid hydrogen fuel is supplied from the fuel tank 212 to the fuel delivery assembly 202. The fuel delivery assembly 202 may include one or more lines, conduits, etc., configured to carry the hydrogen fuel between the fuel tank 212 and the turbofan engine 100. The fuel delivery assembly 202 thus provides a flow path of the hydrogen fuel from the fuel tank 212 to the turbofan engine 100. The hydrogen fuel is delivered to the engine by the fuel delivery assembly 202 in the gaseous phase, the supercritical phase, or both (e.g., the gaseous phase and the supercritical phase). The fuel system 200 thus includes a vaporizer 220 in fluid communication with the fuel delivery assembly 202 to heat the liquid hydrogen fuel flowing through the fuel delivery assembly 202. The vaporizer 220 is positioned in the flow path of the hydrogen fuel between the fuel tank 212 and the turbofan engine 100. The vaporizer 220 may be positioned at least partially within the fuselage 12 or the wing 14 (both shown in FIG. 1), such as at least partially within the wing 14. The vaporizer 220 may, however, be positioned at other suitable locations in the flow path of the hydrogen between the fuel tank 212 and the turbofan engine 100. For example, the vaporizer 220 may be positioned external to the fuselage 12 and the wing 14 (both shown in FIG. 1) and positioned at least partially within the pylon 18 (FIG. 1) or the turbofan engine 100 (FIG. 2). When positioned in the turbofan engine 100, the vaporizer may be located in the nacelle 134, for example. Although only one vaporizer 220 is shown in FIG. 2, the fuel system 200 may include multiple vaporizers 220. For example, when a vaporizer 220 is positioned in the turbofan engine 100 or in the pylon 18 and functions as a primary vaporizer configured to operate once the turbofan engine 100 is in a thermally stable condition, another vaporizer 220 is positioned upstream of the primary vaporizer and proximate to the fuel tank 212, and functions as a primer vaporizer during start-up (or prior to start-up) of the turbofan engine 100.

The vaporizer 220 is in thermal communication with at least one heat source 222, 224. In this embodiment, the vaporizer 220 is in thermal communication with a primary heat source 222 and an auxiliary heat source 224. In this embodiment, primary heat source 222 is waste heat from the turbofan engine 100, and the vaporizer 220 is, thus, thermally connected to at least one of the main lubrication system 171, the compressor cooling air (CCA) system 173, the active thermal clearance control (ATCC) system 175, the generator lubrication system 177, and the heat exchangers 179 to extract waste heat from the turbofan engine 100 to heat the hydrogen fuel. In such a manner, the vaporizer 220 is configured to operate by drawing heat from the primary heat source 222 once the turbofan engine 100 is capable of providing enough heat, via the auxiliary heat source 224, to the vaporizer 220, in order to facilitate operation of the vaporizer 220.

The vaporizer 220 may be heated by any suitable heat source, and, in this embodiment, for example, the auxiliary heat source 224 is a heat source external to the turbofan engine 100. The auxiliary heat source 224 may include, for example, an electrical power source, a catalytic heater or burner, and/or a bleed air flow from an auxiliary power unit. The auxiliary heat source 224 may be integral to the vaporizer 220, such as when the vaporizer 220 includes one or more electrical resistance heaters, or the like, that are powered by the electrical power source. In this configuration the auxiliary heat source 224 may provide heat for the vaporizer 220 independent of whether or not the turbofan engine 100 is running and can be used, for example, during start-up (or prior to start-up) of the turbofan engine 100.

As noted, the vaporizer 220 is in communication with the flow of the hydrogen fuel through the fuel delivery assembly 202. The vaporizer 220 is configured to draw heat from at least one of the primary heat source 222 and the auxiliary heat source 224 to heat the flow of hydrogen fuel from a substantially completely liquid phase to a substantially completely gaseous phase or to a substantially completely supercritical phase.

The fuel system 200 also includes a high-pressure pump 232 in fluid communication with the fuel delivery assembly 202 to induce the flow of the hydrogen fuel through the fuel delivery assembly 202 to the turbofan engine 100. The high-pressure pump 232 may generally be the primary source of pressure rise in the fuel delivery assembly 202 between the fuel tank 212 and the turbofan engine 100. The high-pressure pump 232 may be configured to increase a pressure in the fuel delivery assembly 202 to a pressure greater than a pressure within the combustion chamber 430 of the combustor 150 of the turbofan engine 100, and to overcome any pressure drop of the components placed downstream of the high-pressure pump 232.

The high-pressure pump 232 is positioned within the flow of hydrogen fuel in the fuel delivery assembly 202 at a location downstream of the vaporizer 220. In this embodiment, the high-pressure pump 232 is positioned external to the fuselage 12 and the wing 14, and is positioned at least partially within the pylon 18, or at least partially within the turbofan engine 100. More specifically, the high-pressure pump 232 is positioned within the turbofan engine 100. With the high-pressure pump 232 located in such a position, the high-pressure pump 232 may be any suitable pump configured to receive the flow of hydrogen fuel in substantially completely a gaseous phase or a supercritical phase. In other embodiments, however, the high-pressure pump 232 may be positioned at other suitable locations, including other positions within the flow path of the hydrogen fuel. For example, the high-pressure pump 232 may be located upstream of the vaporizer 220 and may be configured to receive the flow of hydrogen fuel through the fuel delivery assembly 202 in a substantially completely liquid phase.

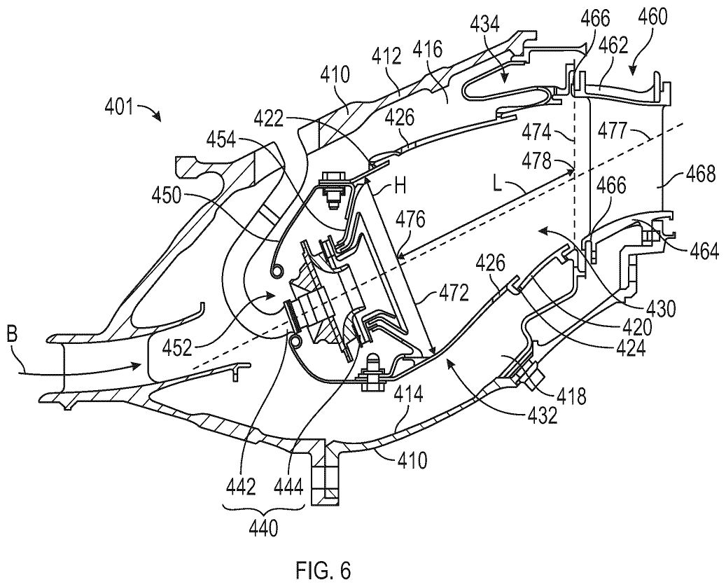

The fuel system 200 also includes a metering unit in fluid communication with the fuel delivery assembly 202. Any suitable metering unit may be used including, for example, a fuel metering valve 234 placed in fluid communication with the fuel delivery assembly 202. The fuel delivery assembly 202 is configured to provide the fuel metering valve 234, and the fuel metering valve 234 is configured to receive hydrogen fuel. In this embodiment, the fuel metering valve 234 is positioned downstream of the high-pressure pump 232. The fuel metering valve 234 is further configured to provide the flow of the hydrogen fuel to the turbofan engine 100 in a desired manner. The fuel metering valve 234 is configured to provide a desired volume of the fuel at, for example, a desired flow rate, to a fuel manifold 236 of the turbofan engine 100. The fuel manifold 236 then distributes (provides) the hydrogen fuel received to a plurality of fuel nozzles 442 (see FIG. 6) within the combustion section 150 of the turbofan engine 100 where the hydrogen fuel is mixed with compressed air, and the mixture of hydrogen fuel and compressed air is combusted to generate combustion gases that drive the turbofan engine 100. Adjusting the fuel metering valve 234 changes the volume of fuel provided to the combustion chamber 430 (see FIG. 6) of the combustor 150 and, thus, changes the amount of propulsive thrust produced by the turbofan engine 100 to propel the aircraft 10.

Although the turbofan engine 100 is shown as a direct drive, fixed-pitch turbofan engine 100, in other embodiments, a gas turbine engine may be a geared gas turbine engine (i.e., including a gearbox between the fan 126 and shaft driving the fan, such as the LP shaft 124), may be a variable pitch gas turbine engine (i.e., including a fan 126 having a plurality of fan blades 128 rotatable about their respective pitch axes), etc. Additionally, in still other exemplary embodiments, the exemplary turbofan engine 100 may include or be operably connected to any other suitable accessory systems. Additionally, or alternatively, the exemplary turbofan engine 100 may not include or be operably connected to one or more of the accessory systems 171, 173, 175, and 177, discussed above.

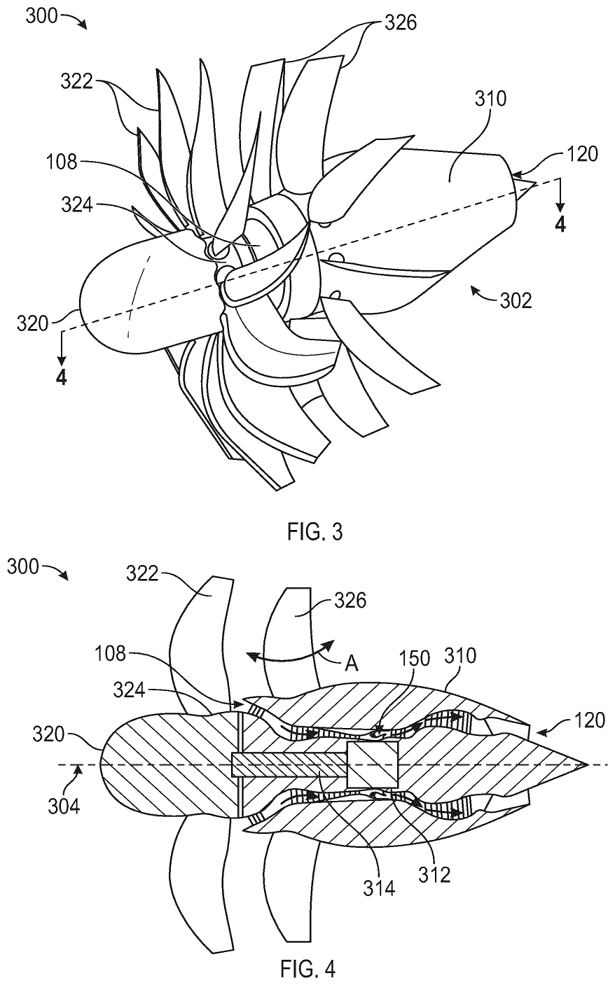

The turbofan engine 100 discussed herein is an example of the engine 20 in which the combustors 150 discussed herein may be used. In other embodiments, other suitable engines may be utilized with aspects of the present disclosure. For example, FIGS. 3 and 4 show an unducted single fan (USF) engine 300 that may be used as the engine 20 of the aircraft 10 and implement the fuel system described above, and combustor designs discussed further below. FIG. 3 is a perspective view of the USF engine 300 and FIG. 4 is a cross-sectional view taken along a line 4-4 in FIG. 3.

The USF engine 300 includes a housing 302. The housing 302 may be formed of a nacelle 310 and spinner 320. The nacelle 310 and/or the spinner 320 house internal components of the USF engine 300. For example, the nacelle 310 houses a torque producing system 312 coupled to a shaft 314. The torque producing system 312 in the embodiments discussed herein is a gas turbine engine, such as the turbomachine 104 discussed above with reference to FIG. 2 and, thus, the nacelle 310 of this embodiment is similar to the tubular outer housing 106 discussed above. As the turbomachine 104 used as the torque producing system 312 of the USF engine has the same or similar components and features as the turbomachine 104 discussed above, a detailed description of the components of the turbomachine 104 used in of the USF engine 300 is omitted.

The torque producing system 312 and the shaft 314 are configured to operate (e.g., to rotate) the spinner 320. One or more fan blades 322 are coupled to the spinner 320. More specifically, the spinner 320 includes a fan hub 324, and the fan blades 322 are coupled to the fan hub 324. The spinner 320 rotates with respect to the nacelle 310. Coupled to the nacelle 310 may be one or more outlet guide vanes 326. In this embodiment, the outlet guide vanes 326 are positioned aft of the fan blades 322. During operation, the one or more fan blades 322 (by virtue of the connection to the spinner 320) rotate circumferentially around a longitudinal centerline 304, in this embodiment, and the nacelle 310 is stationary such that the one or more outlet guide vanes 326 do not rotate around the longitudinal centerline 304 and are, thus, stationary with respect to rotation about the longitudinal centerline 304. Although the outlet guide vanes 326 are stationary with respect to the longitudinal centerline 304, the outlet guide vanes 326 are capable of being rotated or moved with respect to the nacelle 310, for example, in the direction A of FIG. 4.

During operation of the USF engine 300, air flows from the left side of FIG. 4 toward the right side of FIG. 4. A portion of the air flow may flow past the fan blades 322 and the outlet guide vanes 326. A portion of the air flow may enter the nacelle 310 through the annular inlet 108 to be mixed with the hydrogen fuel for combustion in a combustor 150 of the USF engine 300 and exit through an outlet 120. The outlet guide vanes 326 may be movable with respect to the nacelle 310 to guide the air flow in a particular direction. Each outlet guide vane 326 may be movable to adjust the lean, pitch, sweep, or any combination thereof, of the outlet guide vane 326.

In the embodiment shown in FIGS. 3 and 4, a forward end or front portion of the housing 302 includes the one or more fan blades 322 and the one or more outlet guide vanes 326. In other embodiments, the one or more fan blades 322 and the one or more outlet guide vanes 326 may have a different arrangement with respect to the housing 302. For example, the one or more fan blades 322 and the one or more outlet guide vanes 326 may be located on an aft end or rear portion of the housing 302, such as coupled to a rear portion of the housing 302.

In other embodiments, an engine according to the disclosure may be configured to have either the stationary vanes positioned forward of the rotating blades 322 (thus, the blades 326 are inlet guide vanes) or both the blades 326 and blades 322 configured to operate in a counter-rotating fashion. Either “pusher” or “puller” configurations are contemplated. In each of these alternative embodiments, the fuel delivery system 200 and combustor 150, as described in great detail below, may be used. An example of a suitable engine configuration for a counter-rotating engine is shown and described in FIG. 1 and col. 3, line 43 through col. 4, line 11 of U.S. Pat. No. 10,800,512, hereby incorporated by reference for all purposes. Alternative embodiments of the USF engine 300 are shown and described in FIGS. 6, 7, and 8 and col. 4, line 51 through col. 5, line 19 of U.S. Pat. No. 10,704,410, hereby incorporated by reference for all purposes.

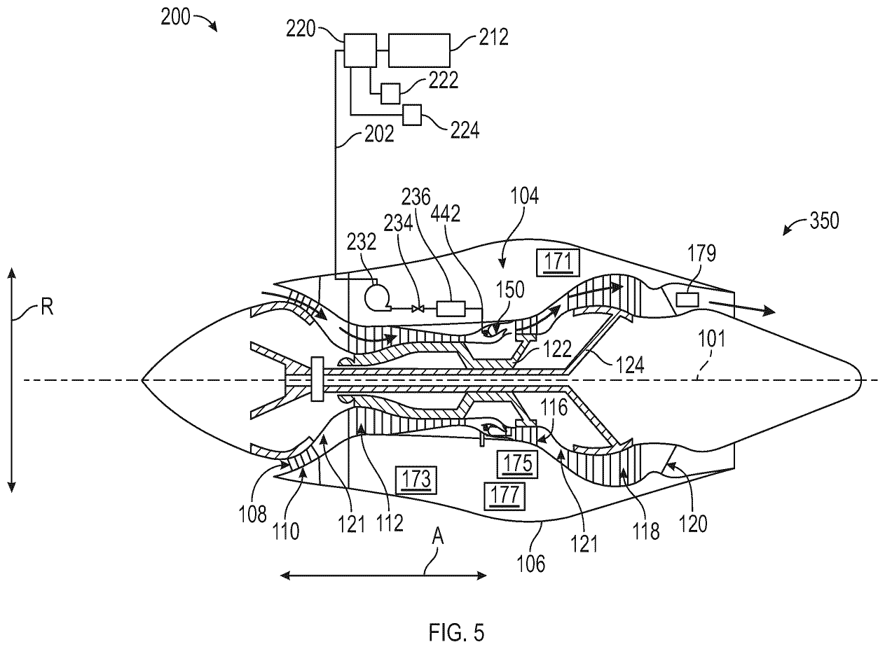

In further embodiments, a turbojet engine 350 may be used as the engine 20. FIG. 5 is a schematic, cross-sectional view of the turbojet engine 350. The cross-sectional view of FIG. 5 is similar to FIG. 2, which is taken along line 2-2 in FIG. 1. The turbojet engine 350 includes the same or similar components of the turbomachine 104 of the turbofan engine 100 and a detailed description of these components is omitted. An exemplary turbojet engine 350 may not include a fan with bypass duct. An exemplary turbojet engine 350 may have high velocity exhaust from the engine, which produces a majority of the thrust for the turbojet engine 350. In still further embodiments, other suitable gas turbine engines, such as a turboshaft engine, a turboprop engine, and the like, may be utilized with aspects of the present disclosure.

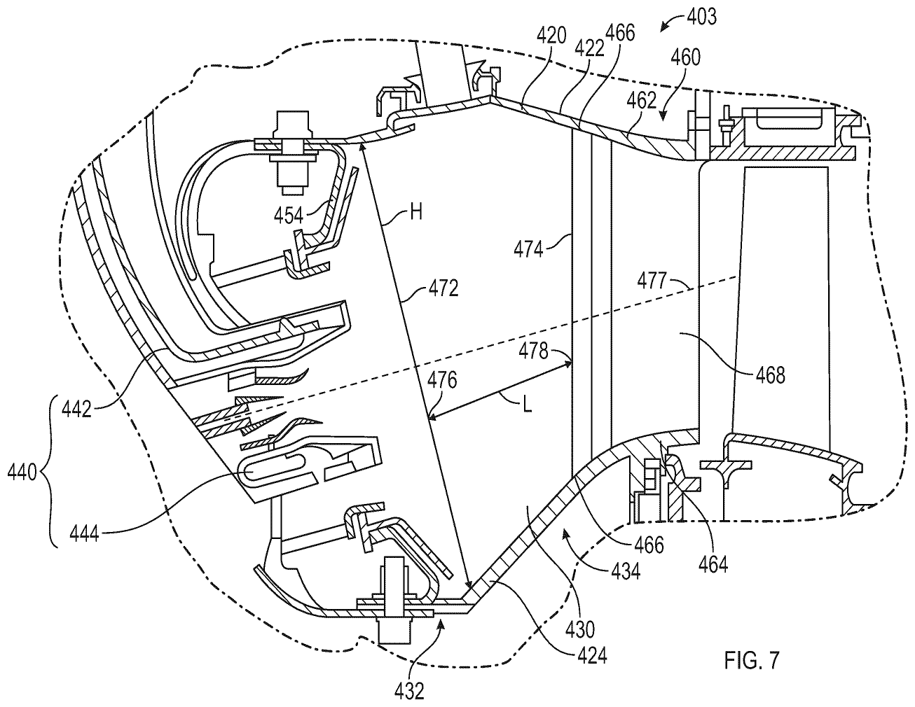

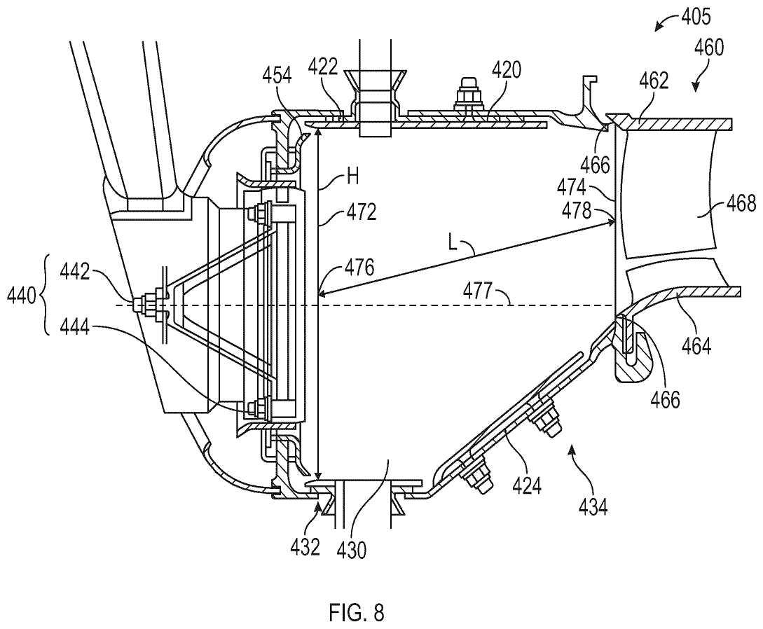

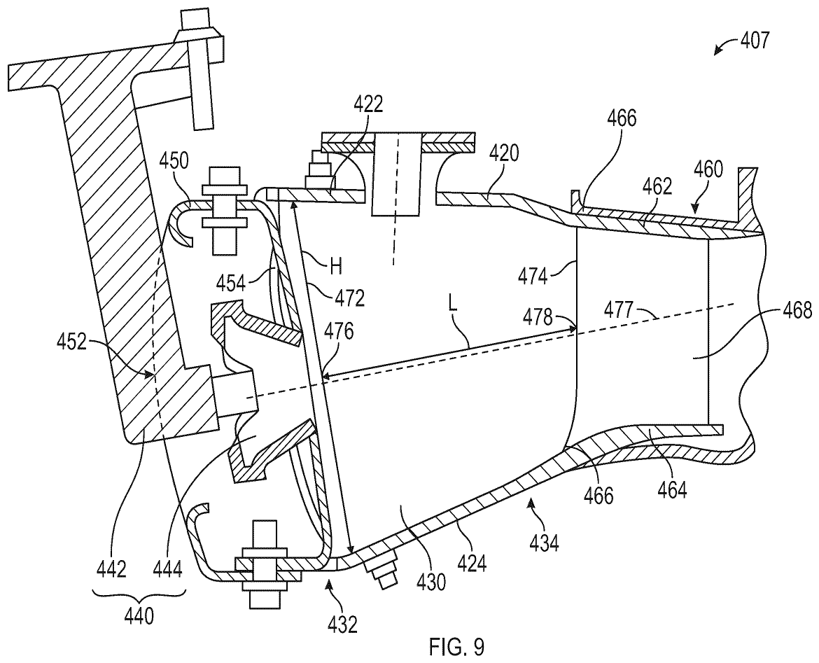

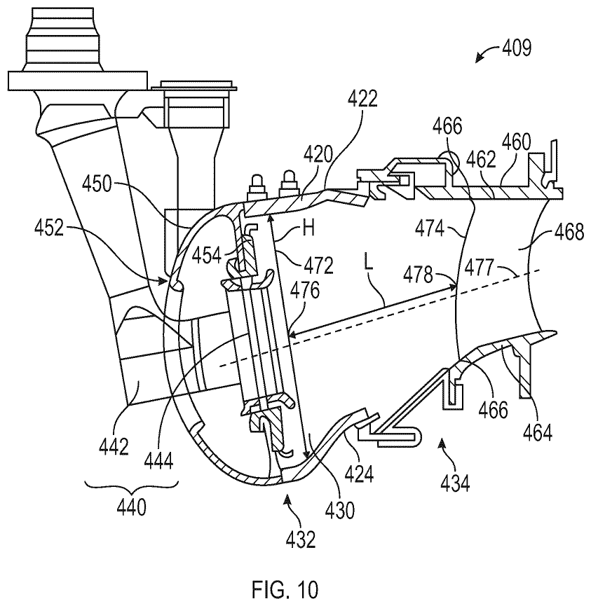

As noted above, we conceived of a wide variety of combustors having different shapes and sizes. FIGS. 6 to 10 show various combustor shapes that can suitably be used as the combustor 150 for the gas turbine engines 20 discussed herein. FIGS. 6 to 10 are a detail views showing detail 6 in FIG. 2, and, as FIG. 2 is a cross-sectional view, FIGS. 6 to 10 are also cross-sectional views. FIG. 6 shows a first combustor 401. FIG. 7 shows a second combustor 403. FIG. 8 shows a third combustor 405. FIG. 9 shows a fourth combustor 407. FIG. 10 shows a fifth combustor 409. Although the shapes of these combustors 401, 403, 405, 407, 409 differ, each of these combustors 401, 403, 405, 407, 409 has similar components, and common reference numerals are used in FIGS. 6 to 10 to for the same or similar components of these combustors 401, 403, 405, 407, 409. Accordingly, the following detailed description of the first combustor 401 also applies to the second combustor 403, the third combustor 405, the fourth combustor 407, and the fifth combustor 409. Some components, such as the combustor casing 410, for example, may not be shown in each figure, but such components may nevertheless be applicable to the combustors 403, 405, 407, 409.

As shown in FIG. 6, combustor 401 includes a combustor casing 410 and a combustor liner 420. The combustor casing 410 of this embodiment has an outer casing 412 and an inner casing 414, and the combustor liner 420 of this embodiment has an outer liner 422 and an inner liner 424. A combustion chamber 430 is formed within the combustor liner 420. More specifically, the outer liner 422 and the inner liner 424 are disposed between the outer casing 412 and the inner casing 414. The outer liner 422 and the inner liner 424 are spaced radially from each other such that the combustion chamber 430 is defined therebetween. The outer casing 412 and the outer liner 422 form an outer passage 416 therebetween, and the inner casing 414 and the inner liner 424 form an inner passage 418 therebetween. In this embodiment, the combustor 401 is a single annular combustor, but, in other embodiments, the combustor 401 may be any other combustor, including, but not limited to a double annular combustor.

The combustion chamber 430 has a forward end 432 (downstream end) and an aft end 434 (upstream end). The fuel nozzle 442 is positioned at the forward end 432 of the combustion chamber 430. The fuel nozzle 442 of this embodiment is part of a swirler/fuel nozzle assembly 440. In this embodiment, when the combustor 401 is an annular combustor 150, a plurality of fuel nozzles 442 is arranged in an annular configuration with the plurality of fuel nozzles 442 (the swirler/fuel nozzle assemblies 440) aligned in a circumferential direction of the combustor 401.

As discussed above, the compressor section, the combustor 401, and the turbine section form, at least in part, the core air flow path 121 extending from the annular inlet 108 to the jet exhaust nozzle section 120. Air entering through the annular inlet 108 is compressed by blades of a plurality of fans of the LP compressor 110 and HP compressor 112. A cowl assembly 450 is coupled to the upstream ends of outer liner 422 and the inner liner 424, respectively. An annular opening 452 formed in the cowl assembly 450 enables compressed air from the compressor section (indicated by arrow B) to enter the combustor 401. The compressed air flows through the annular opening 452 to support combustion. Another portion of the compressed air flows around the outside of the combustor liner 420 through the outer passage 416 and the inner passage 418. This air is introduced into the combustion chamber 430 through a plurality of circumferentially spaced dilution holes 426 formed in the combustor liner 420 at positions downstream of the fuel nozzle 442.

An annular dome plate 454 extends between, and is coupled to, outer liner 422 and the inner liner 424 near their upstream ends. The plurality of circumferentially spaced swirler/fuel nozzle assemblies 440 is coupled to dome plate 454. Each swirler/fuel nozzle assembly 440 receives compressed air from the annular opening 452. The swirler/fuel nozzle assembly 440 includes a swirler 444 that is used to generate turbulence in the air. The fuel nozzle 442 injects fuel into the turbulent air flow and the turbulence promotes rapid mixing of the fuel with the air. The resulting mixture of fuel and compressed air is discharged into combustion chamber 430 and combusted in the combustion chamber 430, generating combustion gases (combustion products), which accelerate as the combustion gases leave the combustion chamber 430.

A turbine nozzle 460 is disposed at the outlet of the combustion chamber 430. The turbine nozzle 460 may be a stage 1 turbine nozzle. The turbine nozzle 460 is coupled to outer liner 422 and the inner liner 424 at the downstream (aft) ends of each of the outer liner 422 and the inner liner 424. The turbine nozzle 460 of this embodiment includes an outer band 462 and an inner band 464 coupled to outer liner 422 and the inner liner 424, respectively. The turbine nozzle 460 also includes a leading edge 466, which in this embodiment is the location where the turbine nozzle 460 is coupled to outer liner 422 and the inner liner 424, and the outer band 462 and the inner band 464 each has the leading edge 466. The turbine nozzle 460 further includes a plurality of circumferentially spaced vanes 468 extending between the outer band 462 and the inner band 464. The vanes 468 extend in a generally radial direction. The vanes 468, and the turbine nozzle 460, is a static component and the vanes 468 may be cured to direct (e.g., spin or swirl) the combustion gases to turn the turbines (e.g., drive the turbine blades) of the first stage of the HP turbine 116. In this embodiment, the turbine section is a multi-stage turbine and these combustion gases will drive subsequent stages of the HP turbine 116 and the LP turbine 118. The turbine nozzle 460 may, thus, also be referred to as a stage one nozzle (SIN). As discussed above the HP turbine 116 and the LP turbine 118, among other things, drive the LP compressor 110 and HP compressor 112.

As noted above, we realized that when designing hydrogen fuel combustor to meet NOx emission targets, the combustor residence time needs to be reduced. We sized the combustor 401, and more specifically, the combustor liner 420 for various gas turbine engines and flow rates. These different embodiments are shown below in Table 1 and were developed for different bypass ratios and thrust classes of engines, characterized by the core airflow. In particular, we considered the height H, also referred to as burner dome height, of the combustion chamber 430 and the length L, also referred to as burner length, of the combustion chamber. Diluents could be used to suppress the temperature, and, thus, NOx production, in the combustion chamber 430 when hydrogen is used as the fuel. With the combustor sized as described in these embodiments, hydrogen fuel can be used without the need of diluents. In some embodiments, no diluent is added to the combustion chamber 430 and the fuel is substantially completely diatomic hydrogen without diluent. As used herein, the term “substantially completely,” as used to describe the amount of a particular element or molecule (e.g., diatomic hydrogen), refers to at least 99% by mass of the described portion of the element or molecule, such as at least 97.5%, such as at least 95%, such as at least 92.5%, such as at least 90%, such as at least 85%, or such as at least 75% by mass of the described portion of the element or molecule.

FIGS. 6 to 10 illustrate how the height H and length L may be determined for the different shapes of combustion liners 420 shown in these figures. The height H of the combustion chamber 430 is taken at the forward end 432 of the combustion chamber 430. The height H is the maximum height between an inner surface of the outer liner 422 and an inner surface of the inner liner 424 at the forward end 432 of the combustion chamber 430. The height H is measured along a line (referred to as a forward line 472, herein) that is generally orthogonal the inner surfaces of the outer liner 422 and the inner liner 424. The forward line 472 may be orthogonal to a central axis 477 of the fuel nozzle assembly 440 and/or the fuel nozzle 442. In this manner, the height H may be orthogonal to the central axis 477. In some embodiments, the height H measured using with the forward line is the maximum height of the combustion chamber 430 and may also be the maximum dome height of the combustion chamber 430.

The length L of the combustion chamber 430 is the distance between forward line 472 and the leading edge 466 of the turbine nozzle 460. As with the height H, a line (referred to as the aft line 474, herein) can be drawn from the leading edge 466 at the outer liner 422 and leading edge at the inner liner 424. Each of the forward line 472 and the aft line 474 has a midpoint (midpoint 476 and midpoint 478, respectively) that is halfway between the outer liner 422 and the inner liner 424. The length L can be measured from the midpoint 476 of the forward line 472 to the midpoint 478 of the aft line 474. The midpoint 478 may be the midspan height of the turbine nozzle 460.

When developing a gas turbine engine, the interplay between components can make it particularly difficult to select or to develop one component during engine design and prototype testing, especially, when some components are at different stages of completion. For example, one or more components may be nearly complete, yet one or more other components may be in an initial or preliminary phase such that only one (or a few) design parameters are known. It is desired to arrive at what is possible at an early stage of design, so that the down selection of candidate optimal designs, given the tradeoffs, become more possible. Heretofore, the process has sometimes been more ad hoc, selecting one design or another without knowing the impact when a concept is first taken into consideration. For example, various aspects of the fan 126 design, the HP compressor 112 design, and/or the LP compressor 110 design may not be known, but such components impact the core air flow through the core air flow path 121, and, thus, may influence the design of the combustion chamber 430.

We desire to narrow the range of configurations or combination of features that can yield favorable results given the constraints of the design, feasibility, manufacturing, certification requirements, etc., early in the design selection process to avoid wasted time and effort. During the course of the evaluation of different embodiments as set forth above, we, the inventors, discovered, unexpectedly, that there exists a relationship between the burner length and the burner dome height, which uniquely identifies a finite and readily ascertainable (in view of this disclosure) number of embodiments suitable for a particular architecture that can meet NOx emissions for hydrogen fuel and provide desired flame residence times. This relationship is referred to by the inventors as the combustor size rating (CSR) (in), and is defined according to the following relationship (1) between burner length L (in) and burner dome height H (in):

$$Combustor Size Rating ( CSR ) = {( L )}^{2} / ( H ) \qquad ( 1 )$$

As discussed further below, we have identified a range of the Combustor Size Ratings that enable a combustion chamber 430 to be designed for a gas turbine engine 20 using hydrogen fuel. This relationship is applicable over a wide range of thrust class and engine designs. Using this unique relationship, a combustor 150 design can be developed early in the design process that meets NOx emissions targets and reduces engine weight for gas turbine engines using hydrogen fuel.

Table 1 describes exemplary embodiments 1 to 24 identifying the CSR for various hydrogen fuel burning engines. The embodiments 1 to 24 may be engines with either rich burn combustors or lean burn combustors. Each of embodiments 1 to 24 burns hydrogen fuel. Embodiments 1 to 24 may represent any of the engines described with respect to FIGS. 1 to 5 and can be applied to any of the combustion chamber 430 shapes shown in FIGS. 6 to 10. In Table 1, the CSR is determined based on the relationship (1) described above. A core air flow parameter (CAFP) (kN) is defined according to the following relationship (2) between thrust (kN) and bypass ratio, both at take off.

$$Core Air Flow Parameter = \frac{Thrust}{Bypass Ratio} \qquad ( 2 )$$

The burner length is the length L identified with respect to FIGS. 6 to 10, and in the embodiments 1 to 24 is between two inches and six inches. In embodiments 1 to 24, the burner length squared may be between six square inches and thirty-five square inches. The burner dome height is the height H identified with respect to FIGS. 6 to 10, and in the embodiments 1 to 24 is between two and one half inches and six inches.

TABLE 1

| | Combustor | Core Air Flow | | |
|---|---|---|---|---|
| | Size Rating | Parameter | Thrust | Bypass |
| Embodiment | (in) | (kN) | (kN) | Ratio |
| 1 | 4.30 | 38.16 | 332.39 | 8.71 |
| 2 | 6.67 | 49.85 | 254.26 | 5.10 |
| 3 | 6.67 | 53.44 | 272.53 | 5.10 |
| 4 | 6.67 | 51.18 | 261.03 | 5.10 |
| 5 | 6.67 | 52.36 | 267.03 | 5.10 |
| 6 | 4.69 | 21.07 | 120.10 | 5.70 |
| 7 | 4.69 | 23.80 | 121.40 | 5.10 |
| 8 | 3.01 | 12.58 | 64.53 | 5.13 |
| 9 | 3.01 | 12.18 | 62.49 | 5.13 |
| 10 | 3.00 | 16.44 | 83.70 | 5.09 |
| 11 | 3.00 | 15.20 | 82.10 | 5.40 |
| 12 | 3.00 | 14.27 | 84.20 | 5.90 |
| 13 | 3.00 | 14.27 | 84.20 | 5.90 |
| 14 | 3.00 | 14.27 | 84.20 | 5.90 |
| 15 | 2.12 | 36.55 | 321.60 | 8.80 |
| 16 | 2.12 | 39.23 | 345.20 | 8.80 |
| 17 | 2.12 | 40.65 | 349.20 | 8.59 |
| 18 | 2.12 | 40.65 | 349.20 | 8.59 |
| 19 | 2.12 | 37.34 | 299.81 | 8.03 |
| 20 | 1.67 | 13.63 | 143.10 | 10.50 |
| 21 | 1.94 | 51.51 | 489.30 | 9.50 |
| 22 | 5.51 | 40.89 | 363.90 | 8.90 |
| 23 | 2.46 | 12.72 | 147.28 | 11.58 |
| 24 | 2.70 | 5.00 | 150.00 | 30.00 |

The length L may be between 2.63 inches and 5.60 inches. The length L may be between two inches and three inches. The length L may be between two and one half inches and three and one half inches. The height H may be between 2.80 inches and 5.60 inches. The height H may be between two and one half inches and six inches. The height H may be between two and one half inches and five inches. The height H may be between four inches and five inches. The burner length squared may be between 6.89 inches and 31.36 inches. The burner length squared may be between six square inches and thirty-five square inches. The burner length squared may be between six square inches and twenty square inches. The burner length squared may be between six square inches and twelve square inches. The burner length squared may be between eight square inches and twelve square inches. The burner length squared and the height may be any values such that the CSR is less than seven inches. The burner length squared and the height may be any values such that the CSR is less than six inches.

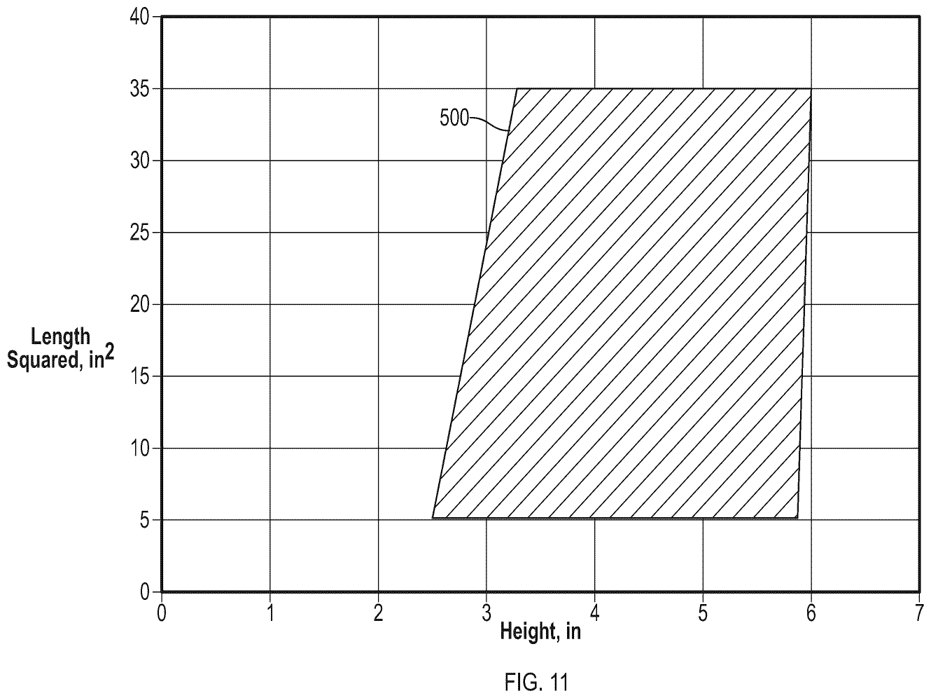

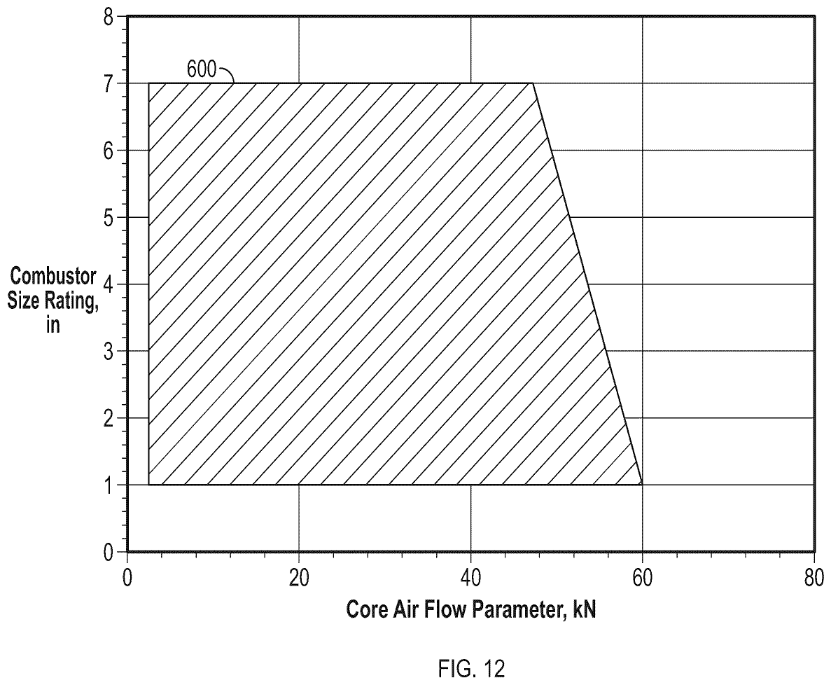

FIG. 11 represents, in graph form, the burner length, squared, as a function of the burner dome height. FIG. 11 shows that the burner length, squared, may be changed based on the burner dome height. An area 500 may present the boundaries of burner length, squared, as a function of burner dome height in which a particular combustor is designed. FIG. 12 represents, in graph form, the CSR as a function of core air flow parameter. Table 1 and FIG. 12 show that CSR may be changed based on a thrust class, as characterized by the core air flow parameter, of an engine. An area 600 may present the boundaries of CSR as a function of the core air flow parameter in which a particular combustor is designed.

As shown in FIG. 12, the CSR is less than seven inches for every core air flow. That is, the CSR is less than seven inches for every thrust class of engine. The CSR may be between 1.67 inches and 6.67 inches. The CSR may be between one inch and seven inches. The CSR may be between one and one half inches and seven inches. The CSR may be between two inches and seven inches. The CSR may be between two inches and six inches. The CSR may be between one inches and five inches. The CSR may be between two inches and five inches. The CSR may be between three inches and five inches. The core air flow parameter may be less than sixty kN. The core air flow parameter may be between five kN and 53.44 kN. The core air flow parameter may be between two and one half kN and sixty kN. The core air flow parameter may be between ten kN and twenty kN. The core air flow parameter may be between thirty kN and forty-five kN.

With continued reference to FIG. 12, the CSR may be a function of the core air flow parameter. The CSR may be based on a thrust of the gas turbine engine. The CSR may be between one inch and seven inches at a core air flow parameter between two and one half kN and sixty kN. The CSR may be between two inches and three and one quarter inches at a core air flow parameter between two and one half kN and fifty kN. The thrust may be between sixty kN and five hundred kN. The thrust may be between 62.49 kN and 489.30 kN. The CSR is defined by a relationship of the burner length, squared, and the burner dome height.

It has been determined that hydrogen fuel results in higher combustion temperatures as compared to combustible hydrocarbon liquid fuel and that NOx emissions are sensitive to factors including combustor residence times. The present disclosure allows for alternate flame shaping and dilution to allow for combustors that are sized to meet NOx emissions targets. In an extension of the concepts disclosed hereinabove, also provided herein is a combustor with a dome wall having dilution openings. The dilution openings can be holes or slots through which compressed air can flow to form a dilution flow that is directed to keep hot gases away from portions of the combustor including a deflector and combustor liner by pushing hot gases away from walls such that mixing occurs away from the wall. Various embodiments described herein provide for uniform temperature distribution downstream of dilution openings. This in turn leads to reduced NOx and lower temperatures on the deflector and liner, which equates to better liner and deflector life.

Further, the dilution opening arrangements described herein enable control of the flame structure within the combustion chamber. The control of the flame structure results in an enhanced control of the flame shape profile. By shaping the flame the liner wall temperature, the dome wall temperature, the combustor exit temperature profile, and the pattern of the flame/gas exiting the combustor is controlled. This control or shaping can further ensure that the combustion section or otherwise hot sections of the turbine engine do not fail or otherwise become ineffective by being overly heated, thus increasing the lifespan of the turbine engine. Further, the introduction of the dilution passage arrangements, as described herein, ensure an even, uniform, or otherwise desired flame propagation within the combustor.

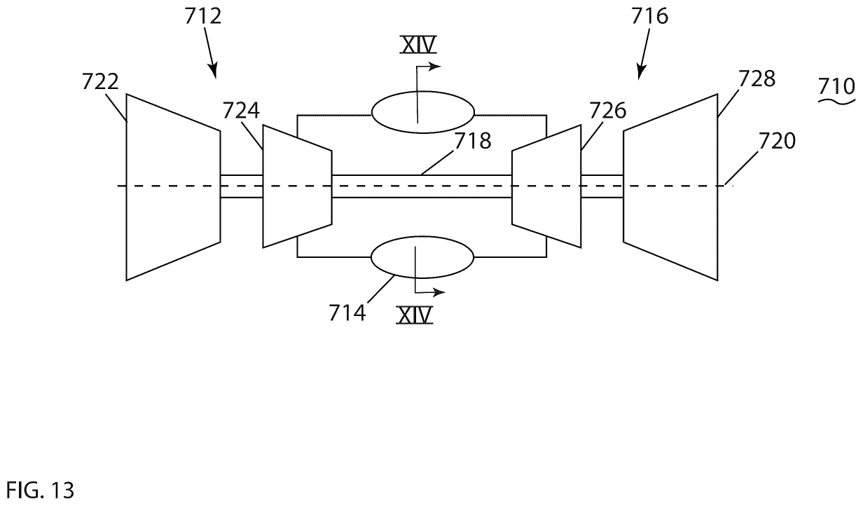

By way of further non-limiting example, FIG. 13 illustrates a turbine engine 710 that can be included in the aircraft 10 of FIG. 1. A compressor section 712, a combustion section 714, and a turbine section 716 in serial flow arrangement are illustrated as being included in the turbine engine 710. A drive shaft 718 rotationally couples the compressor section 712 and turbine section 716, such that rotation of one affects the rotation of the other and defines a rotational axis or engine centerline 721 for the turbine engine 710. A low-pressure (LP) compressor 722 and a high-pressure (HP) compressor 724 can be included in the compressor section and serially fluidly coupled to one another. The turbine section 716 can include an LP turbine 726 and an HP turbine 728 serially fluidly coupled to one another. The drive shaft 718 can operably couple the LP compressor 722, the HP compressor 724, the LP turbine 726 and the HP turbine 728 together. Alternatively, separate LP and HP drive shafts (not shown) can be included with such LP drive shaft coupling the LP compressor 722 to the LP turbine 726 and such HP drive shaft coupling the HP compressor 724 to the HP turbine 728.

The compressor section 712 can include a plurality of axially spaced stages with each stage having rotating blades and stationary vanes. The compressor blades for a stage of the compressor section 712 can be mounted to a disk, which is mounted to the drive shaft 718. Each set of blades for a given stage can have its own disk. The representation of the compressor section 712 is merely schematic and it will be understood that any number of stages and any other number of components within the compressor section 712 can be included. The turbine section 716 can include a plurality of axially spaced stages, with each stage having rotating blades and stationary vanes. Turbine blades for a stage of the turbine section 716 can be mounted to a disk mounted to the drive shaft 718. Each set of blades for a given stage of the turbine section 716 can have its own disk. It will be appreciated that the representation of the turbine section 716 can include any number of blades, vanes and stages and that there can be any other number of components within the turbine section 716. The combustion section 714 can be provided serially between the compressor section 712 and the turbine section 716. The combustion section 714 can at least partially fluidly couple the compressor section 712 to the turbine section 716.

During operation of the turbine engine 710, ambient or atmospheric air is drawn into the compressor section 712 via a fan (not shown) upstream of the compressor section 712, where the air is compressed to define pressurized air. The pressurized air can then flow into the combustion section 714 where the pressurized air is mixed with fuel and ignited, thereby generating combustion gases. Work is extracted from these combustion gases by the HP turbine 728, which drives the HP compressor 724. The combustion gases are discharged into the LP turbine 726, which extracts additional work to drive the LP compressor 722, and the exhaust gas is ultimately discharged from the turbine engine 710 via an exhaust section (not shown) downstream of the turbine section 716. The driving of the LP turbine 726 drives the LP compressor 722. The pressurized airflow and the combustion gases can together define a working airflow that flows through the fan, compressor section 712, combustion section 714, and turbine section 716 of the turbine engine 710.

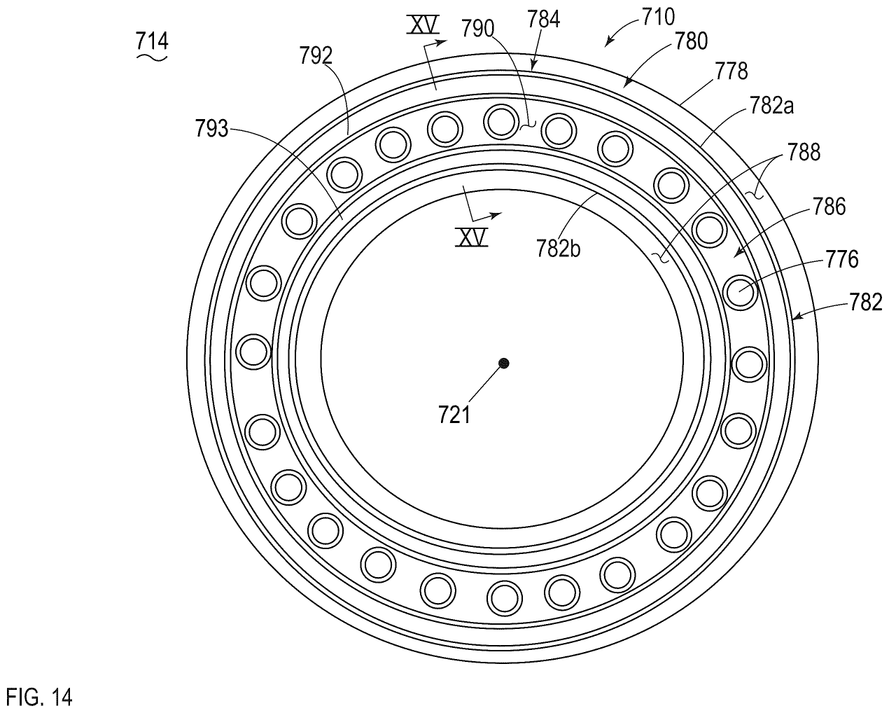

As illustrated in FIG. 14 the combustion section 714 can include an annular arrangement of fuel injectors 776 disposed around the engine centerline 721. Each of the fuel injectors 776 can be connected to combustor 780. It will be understood that the fuel injectors can be one or multiple fuel injectors and one or more of the fuel injectors 776 can have different characteristics. The combustor 780 can have a can, can-annular, or annular arrangement. By way of non-limiting example, an annular arrangement is illustrated and disposed within a casing 778.

The combustor 780 is defined by a combustor liner 782 including an outer annular combustor liner 782a and an inner annular combustor liner 782b concentric with respect to each other and annular about the engine centerline 721. A dome assembly 784 including a dome wall 790 and the combustor liner 782 can define a combustion chamber 786 that is annular about the engine centerline 721. A first set of dilution openings 792 and a second set of dilution openings 793 can be located in the dome wall 790. The first set of dilution openings 792 and the second set of dilution openings 793 can be annularly arranged about the engine centerline 721. The first set of dilution openings 792 and the second set of dilution openings 793 can be annular dilution openings defining a continuous annulus about the engine centerline 721. At least one fuel injector 776 can be fluidly coupled to the combustion chamber 786. A compressed air passageway 788 can be defined at least in part by both the combustor liner 782 and the casing 778.

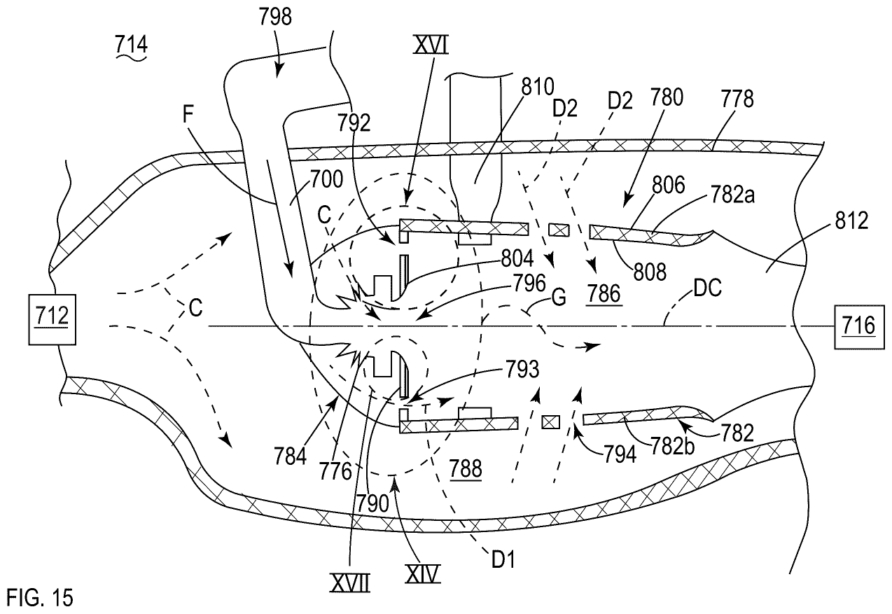

FIG. 15 illustrates a third set of dilution openings 794 located in the combustor liner 782 with the third set of dilution openings 794 connecting the compressed air passageway 788 and the combustor 780. The fuel injector 776 can be coupled to and disposed within the dome assembly 784 upstream of a flare cone 804 to define a fuel/air mixture outlet or mixture outlet 796. The mixture outlet 796 can define a dome inlet such that the mixture outlet and dome inlet are one in the same and fluidly coupled to each other at the flare cone 804. The fuel injector 776 can include a fuel inlet 798 that can be adapted to receive a flow of fuel (F) and a linear fuel passageway 800 extending between the fuel inlet 798 and the mixture outlet 796. The first set of dilution openings 792 can define a swirler provided at the mixture outlet 796 to swirl incoming compressed air (C) in proximity to fuel (F) exiting the fuel injector 776 and provide a homogeneous mixture of air and fuel entering the combustor 780. Both the inner combustor liner 782a and the outer combustor liners 782b can have an outer surface 806 and an inner surface 808 at least partially defining the combustion chamber 786. The combustor liner 782 can be made of one continuous monolithic portion or be multiple monolithic portions assembled together to define the inner combustor liner 782a and the outer combustor liner 782b. The combustor liner 782 can be any type of combustor liner 782 including but not limited to a double walled liner or a tile liner. An igniter 810 can be provided at the combustor liner 782 and fluidly coupled to the combustion chamber 786, at any location including by way of non-limiting example upstream of the third set of dilution openings 794.

During operation, compressed air (C) can flow from the compressor section 772 (FIG. 13) to the combustor 780 through the dome assembly 784. The first set of dilution openings 792 in the dome wall 790 allow passage of at least a portion of the compressed air (C), the portion defining a first dilution airflow (D1), from the dome assembly 784 to the combustion chamber 786. Additionally, compressed air (C) can flow from the compressor section 772 to the combustor 780 through the compressed air passageway 788. The third set of dilution openings 794 in the combustor liner 782 allow passage of at least a portion of the compressed air (C), the portion defining a second dilution airflow (D2), from the compressed air passageway 788 to the combustion chamber 786. Some compressed air (C) can be mixed with the fuel (F) and upon entering the combustor 780, the mixture is ignited within the combustion chamber 786 by one or more igniters 810 to generate combustion gas (G). The combustion gas (G) is mixed using the dilution airflow (D1, D2) supplied through the first set of dilution openings 792, the second set of dilution openings 793, and the third set of dilution openings 794 and mixes within the combustion chamber 786 after which the combustion gas (G) flows through a combustor outlet 812 and exits into the turbine section 774.

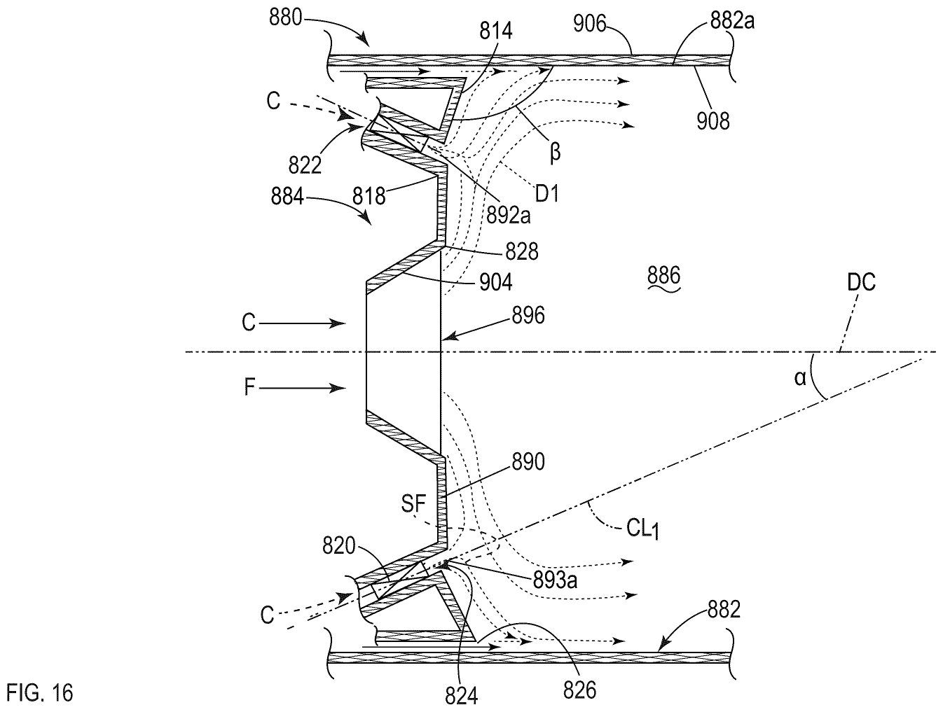

FIG. 16 illustrates a portion of a combustor 880 that is similar to the combustor 780, therefore, like parts will be identified with like numerals increased by 100 with it being understood that the description of the like parts of the combustor 780 applies to the combustor 880 unless otherwise noted. The combustor 880 has a combustion chamber 886 that is defined by a combustor liner 882 and a dome assembly 884 including a dome wall 890. A flare cone 904 can define a mixture outlet 896 and a dome centerline (DC) extending from a geometric center of the flare cone 904. The dome centerline (DC) can be angled with respect to the engine centerline 721 and the dome centerline (DC) can extend in a direction substantially parallel to the engine centerline 721 (FIG. 13). The dome wall 890 can extend radially away from the dome centerline (DC). A first set of dilution openings 89a2 and the second set of dilution openings 893a can be located in the dome wall 890 between the mixture outlet 896 and the combustor liner 882. The first set of dilution openings 892a and the second set of dilution openings 893a can extend between a dilution inlet 822 and a dilution outlet 824 and include at least one vane 820 disposed between the dilution inlet 822 and the dilution outlet 824. In a non-limiting example, the first set of dilution openings 892a and the second set of dilution openings 893a can be annular about the engine centerline 721 (FIG. 13), including concentrically, where the first set of dilution openings 892a circumscribe the second set of dilution openings 893a. There can be any number of vanes 820 oriented circumferentially about the engine centerline 721. The at least one vane 820 can be an axial flow vane, a radial flow vane, or a combination thereof. An axial flow vane moves an airflow in an axial direction, along a primarily longitudinal axis extending parallel to the dome centerline (DC) and a radial flow vane moves air in a radial direction, along a primarily vertical axis extending perpendicular to the dome centerline (DC). A pair of vanes 820 can define a nozzle having first dilution centerline (CL1) angled toward the dome centerline (DC) of the combustion chamber 886. The first dilution centerline (CL1) can make a dilution angle (α) with the dome centerline (DC) that is less than 90°. In some implementations the dilution angle (α) can be less than or equal to 60°.

The dome wall 890 can extend approximately perpendicularly, by way of non-limiting example within five percent, to the dome centerline (DC) from the flare cone 904 toward the outlet 824 of the first set of dilution openings 892 to define a flat portion 816. At least one cooling hole 826 can be located where the dome wall 890 meets the combustion liner 882. The dome wall 890 between the outlet 824 and the at least one cooling hole 826 can be angled toward the combustion liner 882 away from the mixture outlet 896 to define a conic portion 814 with an obtuse angle (β) between the dome wall 890 and the combustion liner 882. The obtuse angle (β) is greater than 90°. In some implementations the obtuse angle (β) can be greater than 130°. The conic portion 814 can meet the flat portion 816 at a first junction 818. The flare cone 904 can meet the dome wall 890 at a second junction 828. During operation, the at least one vane 820 can provide a swirl flow (SF) to the combustion chamber 886. Additionally, the at least one cooling hole 826 can provide additional compressed air (C) for cooling an interior surface 908 of the combustion liner 882.

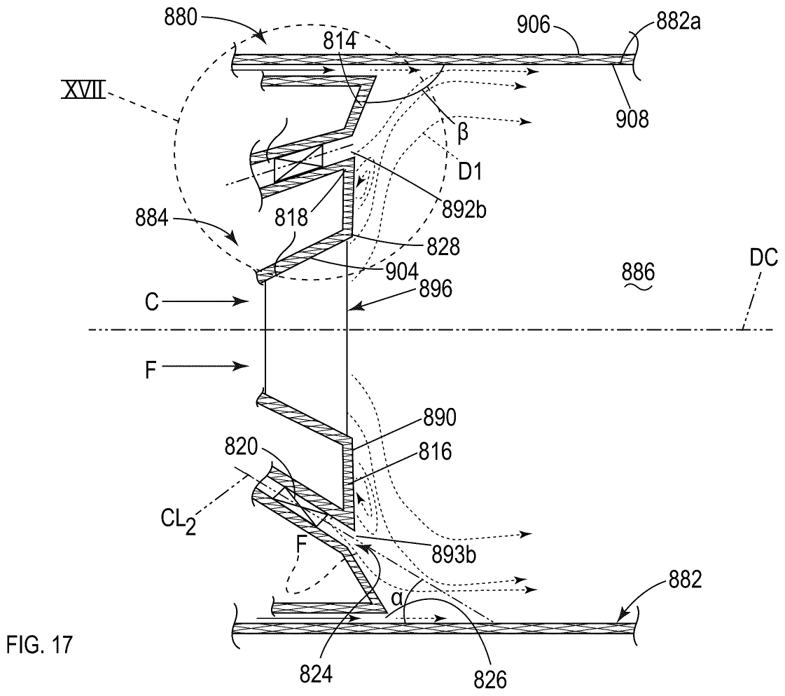

FIG. 17 illustrates the combustor 880 having alternate first set of dilution openings 892b and second set of dilution openings 893b located in the dome wall 890 between the mixture outlet 896 and the combustor liner 882. The second dilution centerline (CL2) is angled away from the dome centerline (DC) of the combustion chamber 886. The second dilution centerline (CL2) can still make a dilution angle (α) with the dome wall 890 that is less than 90°. In some implementations the dilution angle (α) can be less than or equal to 60°. In the illustrated example, the outlet 824 points towards the combustor liner 882. In further non-limiting examples, the dilution angle (α) can vary between −60 and 60 degrees.

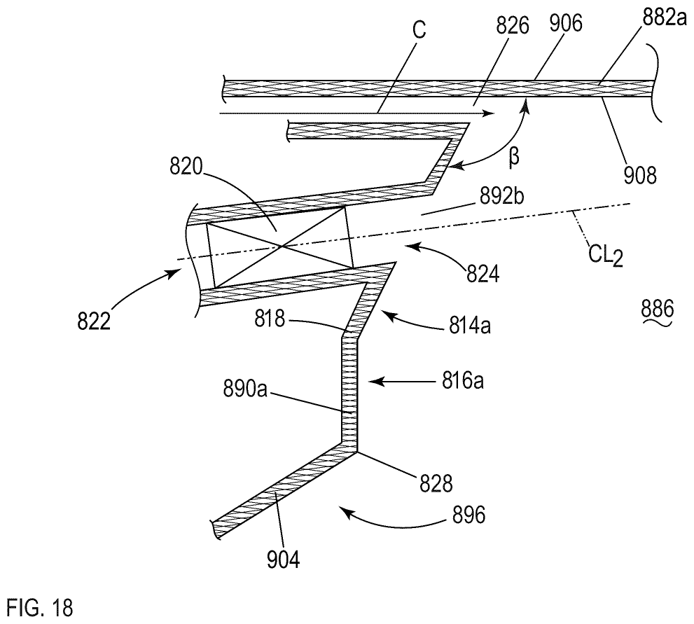

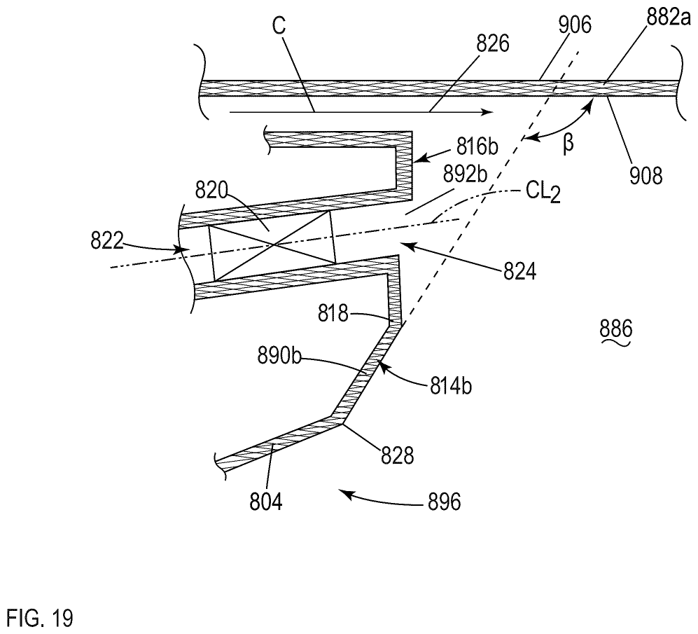

FIG. 18 illustrates an alternate dome wall 890a angled to define a conic portion 814a around the outlet 824 of the first set of dilution openings 892b. The dome wall 890a can include a flat portion 816a extending radially from the second junction 828. The first junction 818 can define a beginning of the conic portion 814a and the conic portion 814a can extend radially from the first junction 818 toward the combustor liner 882 to form the obtuse angle (β). FIG. 19 illustrates yet another alternate dome wall 890b angled to define a conic portion 814b extending radially from the second junction 828 toward the combustor liner 882 to form the obtuse angle (β). The first junction 818 can still be located between the outlet 824 and the end 828 of the flare cone 904. The dome wall 890b can include a flat portion 816b extending radially from the first junction 818 around the outlet 824 of the first set of dilution openings 892b.

While illustrated as having the same cross-section, it should be understood that the dome wall 890, dome wall 890a, dome wall 890b, the conic portion 814, conic portion 814a, conic portion 814b, the flare cone 904 and any other portion of the dome assembly 884 can be formed of materially separate parts. It will be understood that “meet” means the parts described herein overlap at the first junction 818 and second junction 828. While a junction can mean joined physically together, it can also mean overlapping at that point in space.

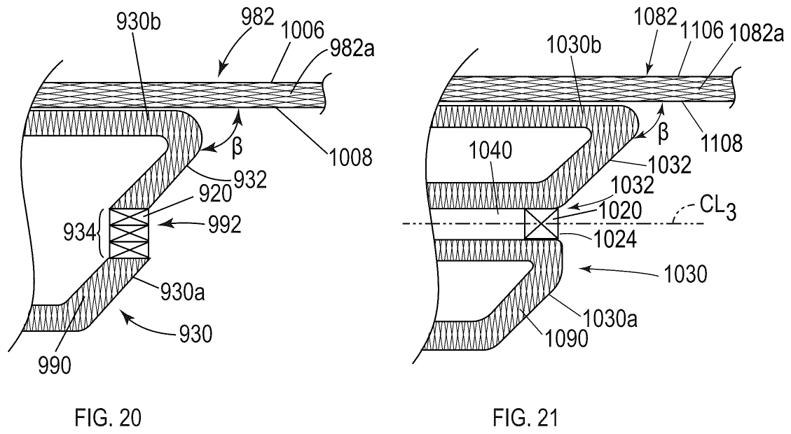

FIG. 20 illustrates a first set of dilution openings 992 that can be included in the combustor 780 (FIG. 15). The first set of dilution openings 992 are substantially similar to the first set of dilution openings 792 with like parts will be identified with like numerals increased by 200 with it being understood that the description of like parts of the first set of dilution openings 792 applies to the first set of dilution openings 992 unless otherwise noted. A dome wall 990 can define a deflector 930 having two parts an inner section 930a and an outer section 930b. The outer section 930b can have a face 932 located axially forward of the inner section 930a. The first set of dilution openings 992 can be disposed between the inner section 930a and the outer section 930b. The first set of dilution openings can include multiple rows 934 of vanes 920 arranged radially with respect to each other.

FIG. 21 is a schematic of a first set of dilution openings 1092 that can be included in the combustor 780 (FIG. 15). The first set of dilution openings 1092 are substantially similar to the first set of dilution openings 792 with like parts will be identified with like numerals increased by 300, the description of the like parts applies to the first set of dilution openings 1092 unless otherwise noted. A dome wall 1090 defines a deflector 1030 having two parts. More specifically, an inner section 1030a and an outer section 1030b with the outer section 1030b having a face 1032 axially forward of the inner section 1030a. The first set of dilution openings 1092 can be disposed between the inner section 1030a and the outer section 1030b. An axially extending passage 1040 defines a third dilution centerline (CL3) that can terminate in an outlet 1024 on the deflector 1030. The axially extending passage 1040 can separate the inner section 1030a from the outer sections 1030b. In a non-limiting example, the axially extending passage 1040 can also define at least one of the openings in the first set of dilution openings 1092. In a further non-limiting example, the axial extending passage 1040 can include at least one vane 1020 disposed within the passage 1040 proximate to the outlet 1024.

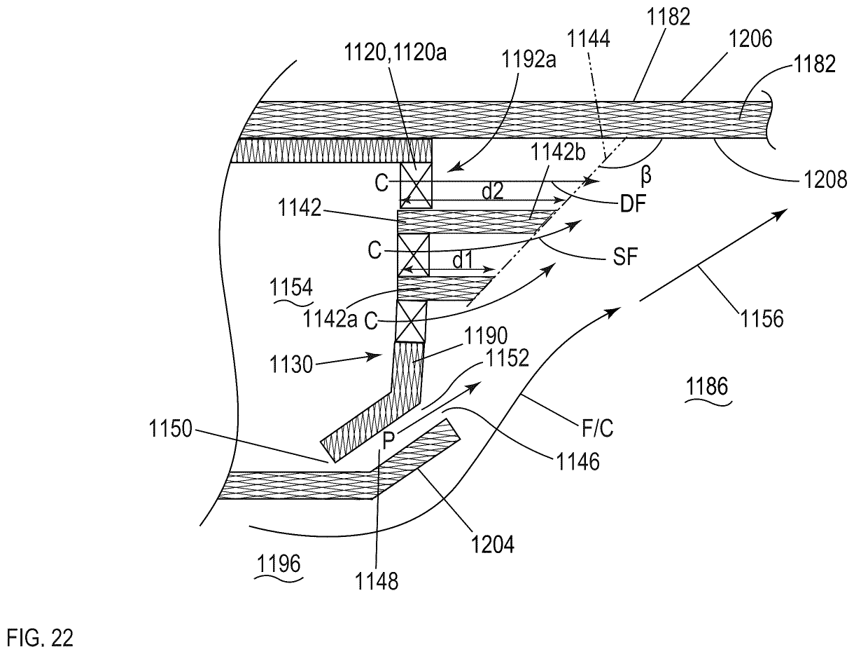

FIG. 22 illustrates a first set of dilution openings 1192a that can be utilized in the combustor 780 (FIG. 15). The first set of dilution openings 1192a are substantially similar to the first set of dilution openings 792 with like parts identified with like numerals increased by 400 and where the description of the like parts applies to the first set of dilution openings 1192a unless otherwise noted. A dome wall 1190 can define a deflector 1130. In the illustrated example, the deflector 1130 can include multiple axial deflectors 1142, by way of non-limiting example two axial deflectors are shown. The axial deflectors 1142 can extend axially away from the dome wall 1190. A first axial deflector 1142a is shown extending axially downstream from the dome wall 1190 a first distance (d1). A second axial deflector 1142b can be located radially outward from the first axial deflector 1142a and the second axial deflector 1142b can extend axially downstream from the dome wall 1190 a second distance (d2) where the second distance (d2) is greater than the first distance (d1). A straight-line 1144 connecting distal ends of the first axial deflector 1142a and the second axial deflector 1142b can be drawn to intersect with a combustor liner 1182 to form an obtuse angle (β).

The first set of dilution openings 1192a can include, by way of non-limiting example three dilution openings radially disposed and separated by the axial deflectors 1142. Thus, the first set of dilution openings 1192a can be disposed within the dome wall 1190 in a staggered relationship with the axial deflectors 1142. Each of the first set of dilution openings 1192a can be flush with the dome wall 1190. The first set of dilution openings 1192a can include at least one vane 1120, or any number of vanes 1120 oriented circumferentially about the flare cone 1204. While illustrated as axial flow vanes 1120a, the at least one vane 1120 can be axial, radial, or a combination thereof.

A third set of dilution openings 1146 can be located around the flare cone 1204. The third set of dilution openings 1146 can include a purge passage 1148 extending between a purge inlet 1150 and a purge outlet 1152. An inlet plenum 1154 can be fluidly coupled to the first set of dilution openings 1192a and the purge passage 1148 at the purge inlet 1150.

During operation compressed air (C) can flow through the first set of dilution openings 1192a to form a dilution flow (DF). In some implementations the flow through the first set of dilution openings 1192a can form a swirl flow (SF). Any particles remaining in the inlet plenum 1154 can be removed via the third set of dilution openings 1146 as a purged airflow (P). A fuel/air (F/C) mixture can flow along a path illustrated by arrows 1156. The purge flow (P) is further utilized for cooling of the flare cone 1204 and to ensure that the fuel/air (F/C) mixture does not attach to a hot side of the dome wall 1190. The path illustrated by arrows 1156 can be controlled by a combination of the dilution flow (DF), the swirl flow (SF) and the purged airflow (P).

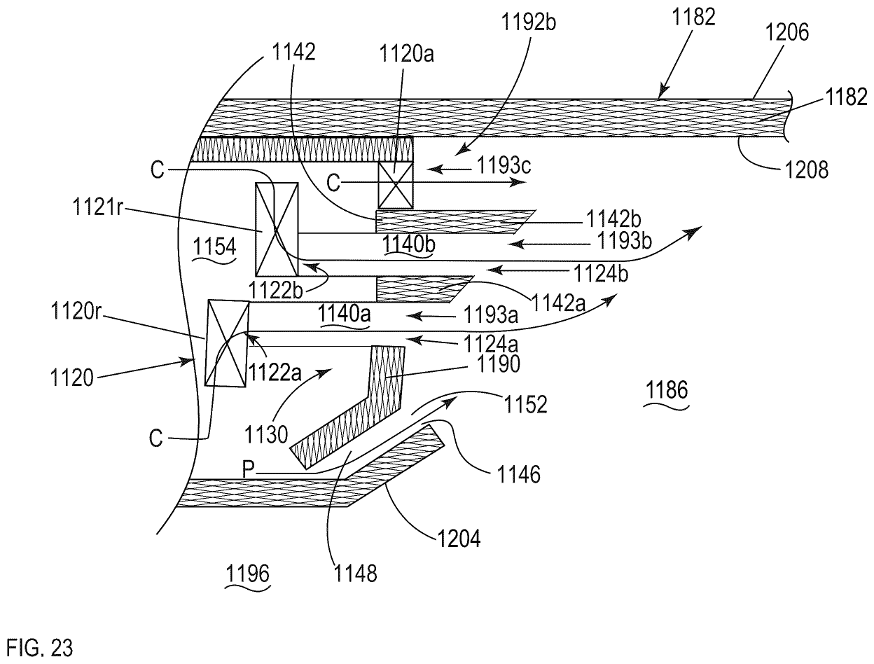

FIG. 23 illustrates a first set of dilution openings 1192b, which are a variation of the first set of dilution openings 1192a of FIG. 22. The first set of dilution openings 1192b are located in the dome wall 1190 between a mixture outlet 1196 and the combustor liner 1182. The first set of dilution openings 1192b can be defined at least in part by at least one vane 1120, or any number of vanes 1120 oriented circumferentially about the flare cone 1204. The first set of dilution openings 1192b can include an inner opening 1193a, an outer opening 1193c, and a middle opening 1193b disposed between the inner opening 1193a and outer opening 1193c. The outer opening 1193c can be located proximate the combustor liner 1182 and include an axial flow vane 1120a.

A pair of radial flow vanes, indicated as a first radial flow vane 1120r and a second radial flow vane 1121r, can be disposed axially upstream of the dome wall 1190 in fluid communication with the inlet plenum 1154. A first axially extending passage 1140a can extend from a first dilution inlet 1122a at the first radial flow vane 1120r to a first dilution outlet 1124a at the dome wall 1190. The first radial flow vane 1120r can extend from the first dilution inlet 1122a radially inward, in a direction away from the combustor liner 1182. While illustrated as extending radially inward, the first radial flow vane 1120r can extend radially outward or both the first radial flow vane 1120r and the second radial flow vane 1121r can extend radially outward.

A second axially extending passage 1140b can extend from a second dilution inlet 1122b at the second radial flow vane 1121r to a second outlet 1124b at the distal ends of the first axial deflector 1142a and the second axial deflector 1142b. The second radial flow vane 1121r can extend from the second dilution inlet 1122b radially outward and in a direction toward the combustor liner 1182. While illustrated as extending radially outward, the second radial flow vane 1121r can extend radially inward or both the first radial flow vane 1120r and the second radial flow vane 1121r can extend radially inward.

In addition to flow previously described, compressed air (C) can travel through the first axial flow vane 1120a and exhaust proximate the combustor liner 1182. Compressed air (C) proximate the mixture outlet 1196 can be radially drawn into first axially extending passage 1140a by the first radial flow vane 1120r. The second radial flow vane 1121r can mirror the first radial flow vane 1120r by drawing compressed air (C) from proximate the combustor liner 1182 into the second axially extending passage 1140b, or vice versa depending on the vane orientation. The first radial flow vane 1120r and the second radial flow vane 1121r can be recessed from the dome wall 1190 to give sufficient axial length for flow to develop before exiting the dome wall 1190.

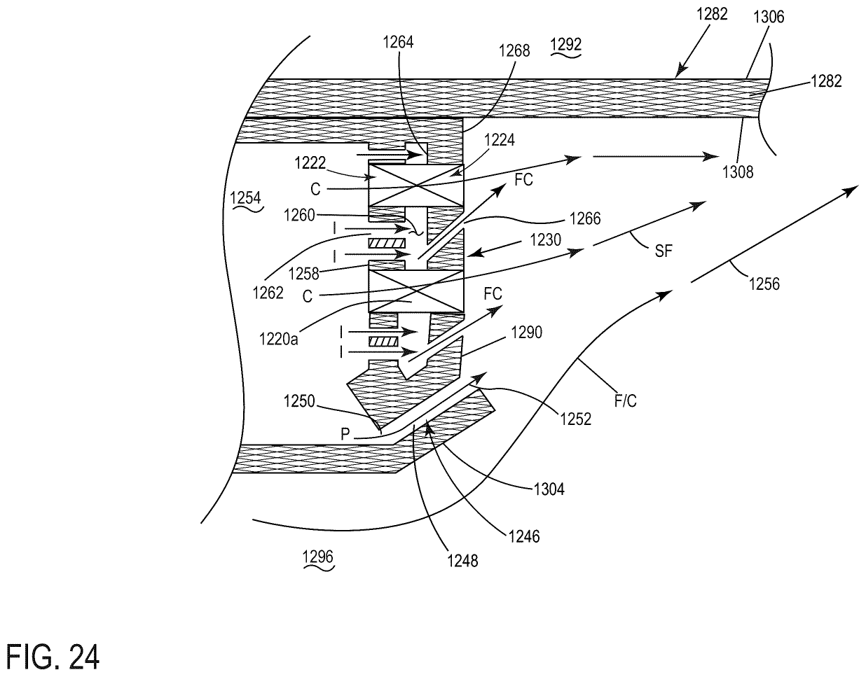

FIG. 24 is a schematic of a first set of dilution openings 1292 that can be included in the combustor 780 (FIG. 15). The first set of dilution openings 1292 are substantially similar to the first set of dilution openings 792 with like parts will be identified with like numerals increased by 500 and where the description of the like parts applies to the first set of dilution openings 1292 unless otherwise noted. A dome wall 1290 can include a deflector 1230 and an impingement wall 1258 spaced apart to define an intermediate plenum 1260. The first set of dilution openings 1292 can include, by way of non-limiting example, two dilution openings radially disposed within the dome wall 1290. The first set of dilution openings 1292 can be defined at least in part by an axial flow vane 1220a extending between a dilution inlet 1222 at the impingement wall 1258 and a dilution outlet 1224 at the deflector 1230. A third set of dilution openings 1246 can be located around a flare cone 1304. The third set of dilution openings 1246 can include a purge passage 1248 extending between a purge inlet 1250 and a purge outlet 1252. An inlet plenum 1254 can be fluidly coupled to the first set of dilution openings 1292 and the purge passage 1248 at the purge inlet 1250. A set of impingement holes 1262 can be located in the impingement wall 1258 surrounding the dilution inlets 1222 of the first set of dilution openings 1292. The impingement holes 1262 can exhaust into the impingement plenum 1260 for impingement onto an inner surface 1264 of the deflector 1230. A set of film cooling holes 1266 can be located in the deflector 1230. The set of film cooling holes 1266 can fluidly couple the impingement plenum 1260 to an exterior surface 1268 of the deflector 1230. It is further contemplated that the set of film cooling holes 1266 fluidly couple the inlet plenum 1254, the impingement plenum 1260, the first set of dilution openings 1292, or a combination thereof to the exterior surface 1268.

It should be understood that while the cross-sectional view illustrated shows all the holes/openings in the same plane, each of the holes/openings can be distributed circumferentially about a mixture outlet 1296 in any suitable manner. In addition to flow described previously herein, during operation compressed air (C) can pass through the set of impingement holes 1262 and impinge onto the inner surface 1264 of the deflector 1230 to define an impingement flow (I). Compressed air (C) can pass through the set of film cooling holes 1266 and exhaust onto the exterior surface 1268 to define a film cooling flow (FC).

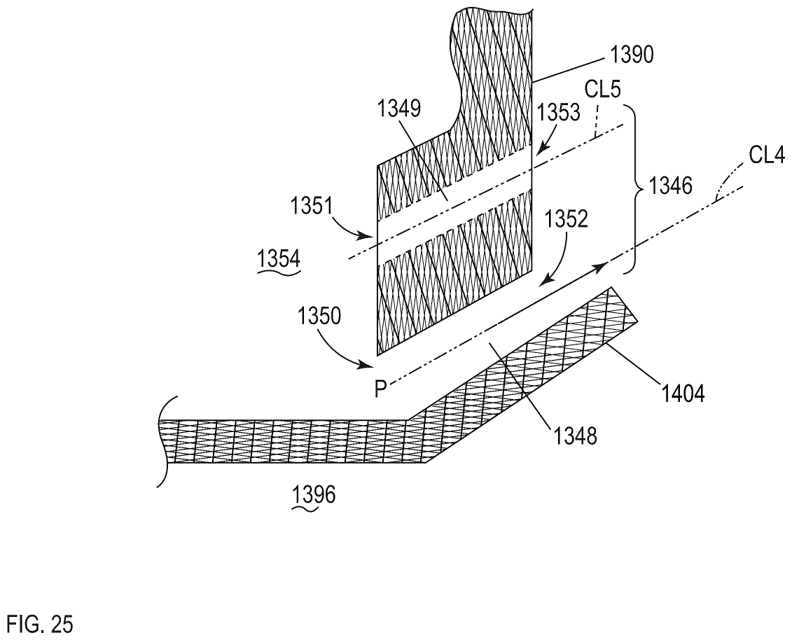

FIG. 25 illustrates a portion of a flare cone 1404 and a dome wall 1390 that can be utilized in the combustor 780 (FIG. 15). The flare cone 1404 and a dome wall 1390 are substantially similar to the flare cone 804 and dome wall 790, respectively, therefore like parts will be identified with like numerals increased by 600 and wherein the description of like parts applies to the flare cone 1404 and the dome wall 1390 unless otherwise noted. The flare cone 1404 can define a mixture outlet 1396. A third set of dilution openings 1346 can be located around the flare cone 1404. The third set of dilution openings 1346 can include a purge passage 1348 extending between a purge inlet 1350 and a purge outlet 1352 parallel to and proximate the flare cone 1404. The purge passage 1348 can define a fourth centerline (CL4) angled away from mixture outlet 1396. The third set of dilution openings 1346 can further include a peripheral dilution passage 1349 extending between a dilution inlet 1351 and a dilution outlet 1353 radially outward the purge passage 1348. The peripheral passage 1349 can define a fifth dilution centerline (CL5) angled away from the mixture outlet 1396. The fourth dilution centerline (CL4) and the fifth dilution centerline (CL5) can be parallel to each other, or within 20% of parallel to each other. An inlet plenum 1354 can be fluidly coupled to the third set of dilution openings 1346 at the inlets 1350, 1351.

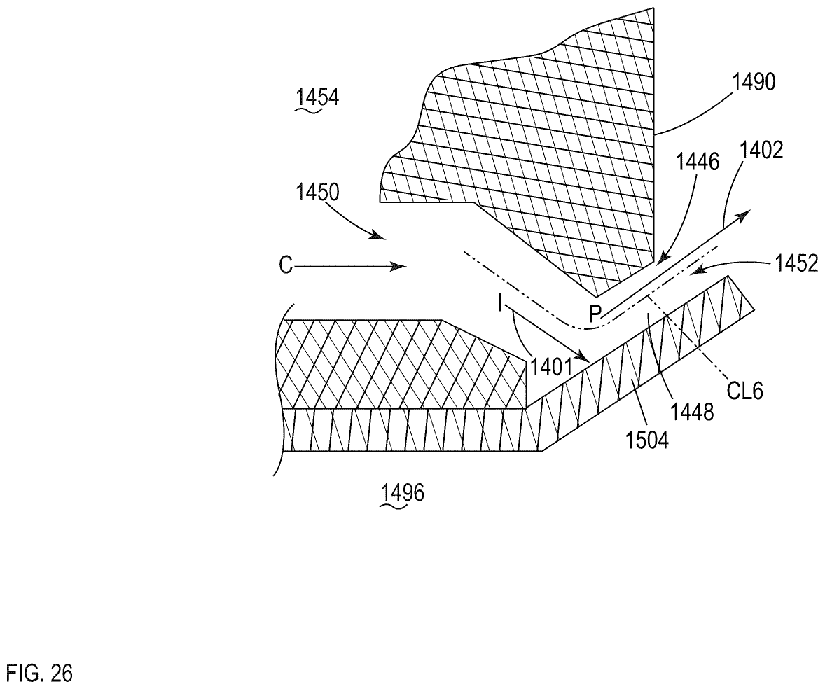

FIG. 26 illustrates a portion of flare cone 1504 and dome wall 1490 arrangement that can be utilized in the combustor 780 (FIG. 15). The flare cone 1504 and the dome wall 1490 are substantially similar to the flare cone 804 and dome wall 790 and therefore like parts will be identified with like numerals increased by 700 with it being understood that the description of the like parts applies to the flare cone 804 and the dome wall 1490 unless otherwise noted. The flare cone 1504 can define a mixture outlet 1496. A third set of dilution openings 1446 can be located around the flare cone 1504 and the third set of dilution openings 1446 can include a purge passage 1448 extending between a purge inlet 1450 and a purge outlet 1452 parallel to and proximate the flare cone 1504. The purge passage 1448 can define a sixth dilution centerline (CL6) angled in a first direction, illustrated with arrow 1401 toward the flare cone 1504 and then angled in a second direction illustrated with arrow 1402 away from the flare cone 1504. An inlet plenum 1454 can be fluidly coupled to the third set of dilution openings 1446 at the purge inlets 1450. During operation compressed air (C) can flow through the third set of dilution openings 1446 to first form an impingement flow (I). The impingement flow (I) can turn away from the mixture outlet 1496 and exhaust through the outlet 1452 as a purged airflow (P).

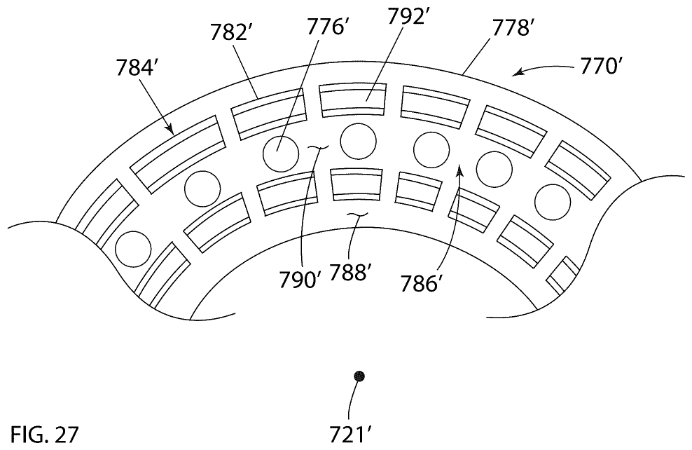

FIG. 27 illustrates an alternative combustion section 770′ that can be utilized within the turbine engine 710 (FIG. 13). Similar primed numbers are utilized with it being understood that the description of like parts applies unless otherwise noted. In this variation the first set of dilution openings 792′ can be segmented dilution openings, where the first set of dilution openings 792′ are circumferentially disposed around the engine centerline 721′ within the dome wall 790′ in a segmented annulus as illustrated. Therefore, the vanes as described herein can also be disposed around the engine centerline 721′ in a segmented arrangement.

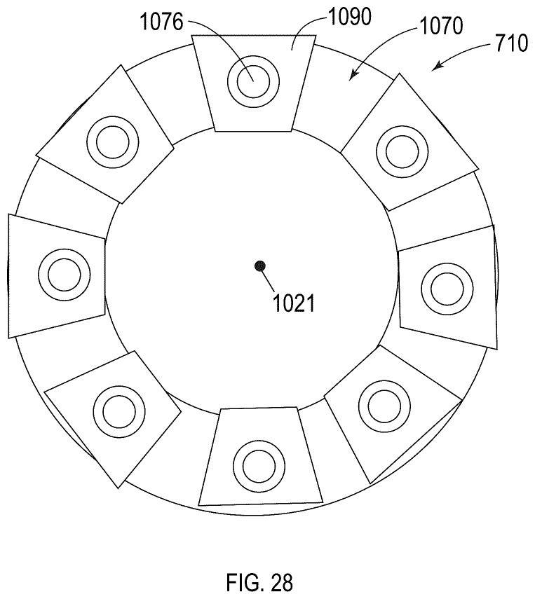

FIG. 28 is a cross-sectional view of a combustion section 1070 that can be utilized in the turbine engine 710 (FIG. 13). The combustion section 1070 is a variation of the combustion section 770′ of FIG. 27. One difference is that an arrangement of dome walls 1090 is included about an engine centerline 1021. Each of the dome walls 1090 described hereafter can include discrete dilution openings arranged about the engine centerline 1021. This is a variation of the annular dilution openings illustrated in FIG. 14.

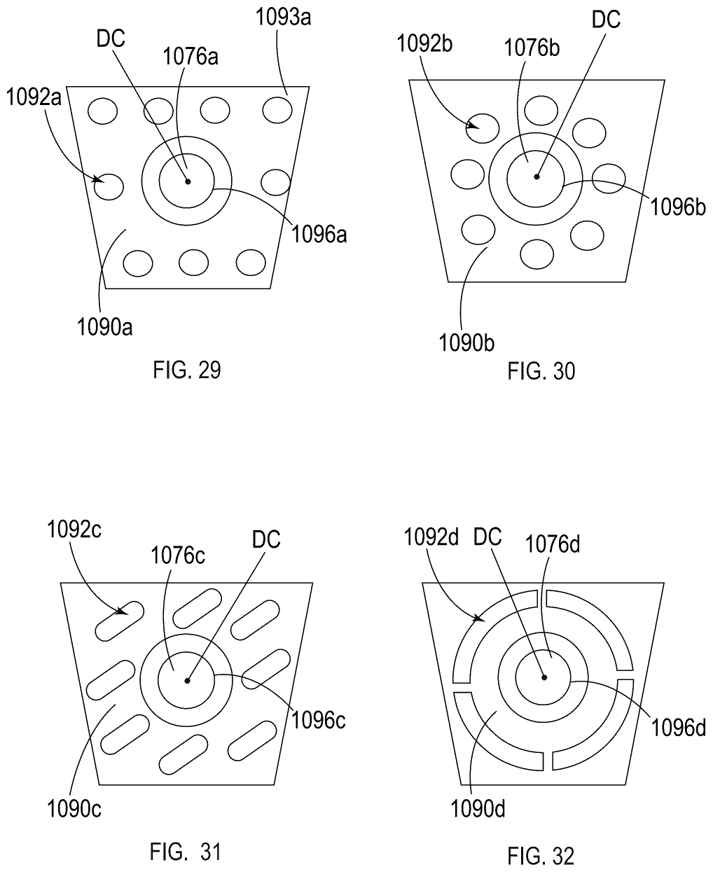

FIG. 29 illustrates a set of dilution openings 1092a that can be located within the dome wall 1090a including by way of non-limiting example within the combustion section 1070 of FIG. 28. Any number of variations for one or more sets of dilution openings arranged about the mixture outlet 1096a are contemplated. By way of non-limiting example, the set of dilution openings 1092a are provided in corners 1093 and along the periphery of the dome wall 1090.

FIG. 30 illustrates an alternative exemplary distribution for a set of dilution openings 1092b located within a dome wall 1090b. The set of dilution openings 1092b are similar to those described in FIG. 29 and similar numerals will be utilized. One difference is that the set of dilution openings 1092b is arranged annularly about a mixture outlet 1096b for flame shaping and to prevent high temperature on the combustor liner 782 (FIG. 15).

FIG. 31 illustrates another alternative exemplary distribution for a set of dilution openings 1092c located within a dome wall 1090c. The set of dilution openings 1090c is similar to those described in FIG. 30 and similar numerals will be utilized. One difference it that the sets of dilution openings 1090c include slotted openings arranged about the mixture outlet 1096c. The slotted openings can have any shape by way of non-limiting examples including racetrack, circular, or elliptical. Further, the slotted openings can be oriented in any suitable manner including, by way of non-limiting example, angled with respect to the radial direction as illustrated.

FIG. 32 illustrates another exemplary distribution for a set of dilution openings 1092d located within a dome wall 1090d. The set of dilution openings 1090d is similar to those described in the FIG. 30 and similar numerals will be utilized. One difference is that the sets of dilution openings 1090d are annular about the dome centerline (DC) and are arranged about the mixture outlet 1096d. Further still, the set of dilution openings 1092d are annular slotted openings circumscribing at least a portion of a periphery of the the mixture outlet 1096d.

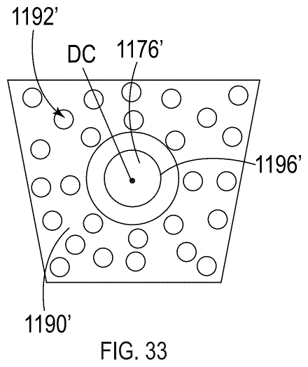

FIG. 33 is yet another exemplary distribution for a set of dilution openings 1192 located within the dome wall 1190, the set of dilution openings are similar to the arrangement in FIG. 29 and are numbered in the 1100 series. The set of dilution openings 1192 is arranged in array about the mixture outlet 1196. The set of dilution openings 1192 can be considered a cumfrential array that circumscribes at least a portion of mixture outlet 1196. As illustrated not all portions of the array circumbscribing the mixture outlet 1196 include a same number of openings. In the illustrated example there are groupings or subsets of three openings, two openings and a single opening as the array circumscribes the mixture outlet 1196.

Any combination of the exemplary dome walls and variations of the dilution openings locations described herein are contemplated. FIGS. 16-33 are for illustrative purposes only and not meant to be limiting. The dilution holes/slotted openings can be in any form described herein. The deflector as described herein can be fed directly from under cowl region or implement a double pressure drop design. The compressed air as described herein can be a dilution flow with swirl that is generated by axial/radial flow vanes as described herein. It should be understood that the dilution flow as described herein can be arranged about a swirler axis or an engine axis. Each exemplary arrangement produces a dilution flow that is directed to keep hot gases away from the deflector and combustor liner by pushing hot gases away from walls such that mixing occurs away from the wall. The deflector as described herein can be cooled by back-side or film cooling or both. It should be appreciated that the dilution openings as described herein are exemplary as illustrated. The dilution openings can be organized in a myriad of different ways, and can include by way of non-limiting example ribs, pin banks, circuits, sub-circuits, film-openings, plenums, mesh, and turbulators, of any shape or size. The dilution openings can include other flow enhancing devices, by way of non-limiting example a small opening located behind the dilution opening. It is further contemplated that the dilution openings can be part of a collection of dilution openings. It is also contemplated that the dilution openings can be in addition to and separate from a collection of cooling openings located along the combustor liner. A method for controlling NOx present in combustion gases (G) within the combustor 780 (FIG. 15), includes injecting the dilution airflow (D) into the combustion chamber as described herein through the dilution openings located in the dome walls described herein at the angles described herein. The method can further includes injecting a purge flow (P) into the combustor as described herein.

Benefits associated with the structures and methods described herein are uniform temperature distribution downstream of dilution openings which along with reduced residence times equates with better NOx and combustor exit temperature profiles. A lower temperature on the deflector and liner equate with a better liner and deflector life. Further the dilution opening arrangements described herein enable control of the flame structure within the combustion chamber. While described with respect to a gas turbine engine, it should be appreciated that the combustor as described herein can be for any engine with a having a combustor that emits NOx. It should be appreciated that application of aspects of the disclosure discussed herein are applicable to engines with propeller sections or fan and booster sections along with turbojets and turbo engines as well.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the present disclosure are provided by the subject matter of the following clauses.

A gas turbine engine includes a hydrogen fuel delivery assembly configured to deliver a hydrogen fuel flow, a compressor section configured to compress air flowing therethrough to provide a compressed air flow, and a combustor including a combustion chamber having a burner length L and a burner dome height H, the combustion chamber configured to combust a mixture of the hydrogen fuel flow and the compressed air flow, and the combustion chamber being characterized by a combustor size rating between one inch and seven inches.

The gas turbine engine of the preceding clause, wherein the combustor further includes an outer liner and an inner liner, the combustion chamber having a forward end and being defined between the outer liner and the inner liner, each of the outer liner and the inner liner having an inner surface, and wherein His the maximum height between the inner surface of the outer liner and the inner surface of the inner liner at the forward end of the combustion chamber.

The gas turbine engine of any preceding clause, wherein the combustor size rating is between two inches and seven inches.

The gas turbine engine of any preceding clause, wherein the combustor size rating is between two inches and six inches.

The gas turbine engine of any preceding clause, wherein the combustor size rating is between three inches and six inches.

The gas turbine engine of any preceding clause, wherein the burner length is between two inches and six inches.

The gas turbine engine of any preceding clause, wherein the burner length is between two inches and three inches.

The gas turbine engine of any preceding clause, wherein the burner length is between two and one half inches and three and one half inches.

The gas turbine engine of any preceding clause, wherein the burner dome height is between two and one half inches and six inches.

The gas turbine engine of any preceding clause, wherein the burner dome height is between two and one half inches and five inches.

The gas turbine engine of any preceding clause, wherein the burner dome height is between four inches and five inches.

The gas turbine engine of any preceding clause, wherein the burner length, squared, is between six square inches and thirty-five square inches.

The gas turbine engine of any preceding clause, wherein the burner length, squared, is between six square inches and twenty square inches.

The gas turbine engine of any preceding clause, wherein the burner length, squared, is between six square inches and twelve square inches.

The gas turbine engine of any preceding clause, wherein the burner length, squared, is between eight square inches and twelve square inches.

The gas turbine engine of any preceding clause, wherein no diluent is added to the combustion chamber.

The gas turbine engine of any preceding clause, wherein the combustor size rating is defined by a relationship of the burner length, squared, and the burner dome height.

The gas turbine engine of any preceding clause, further comprising a turbine nozzle downstream of the combustion chamber, wherein L is the distance between a plane orthogonal to a forward line at which the burner dome height is measured and a leading edge of the turbine nozzle.

The gas turbine engine of any preceding clause, further comprising one or more rotating blades.

The gas turbine engine of any preceding clause, further comprising one or more stationary vanes, wherein the one or more stationary vanes are positioned forward of the rotating blades.

The gas turbine engine of any preceding clause, further comprising one or more stationary vanes, wherein the one or more stationary vanes are positioned aft of the rotating blades.

The gas turbine engine of any preceding clause, further comprising a first set of one or more rotating blades and a second set of rotating blades, the first set of rotating blades and the second set of rotating blades being configured to operate in a counter-rotating fashion.

The gas turbine engine of any preceding clause, further comprising a plurality of fan blades located forward of the combustor in a puller configuration.

The gas turbine engine of any preceding clause, further comprising a plurality of fan blades, the combustor located forward of the plurality of fan blades in a pusher configuration.

The gas turbine engine of any preceding clause, wherein the gas turbine engine is one of a turbofan engine, an unducted single fan engine, a turbojet engine, a turboshaft engine, or a turboprop engine.

The gas turbine engine of any preceding clause, wherein the gas turbine engine is a turbofan engine comprising an outer nacelle that houses the compressor section, the combustor, and a plurality of fan blades.

The gas turbine engine of any preceding clause, wherein the gas turbine engine is an unducted single fan engine comprising a spinner coupled to a nacelle, the nacelle housing the compressor section and the combustor, a plurality of outlet guide vanes coupled to an outer surface of the nacelle, and a plurality of fan blades coupled to the spinner and rotatable therewith.

The gas turbine engine of any preceding clause, wherein the gas turbine engine is a turbojet engine comprising an outer nacelle that houses the compressor section and the combustor, the turbojet engine not including a fan with bypass duct.

The gas turbine engine of any preceding clause, further including a hydrogen fuel tank for holding the hydrogen fuel in a liquid phase, the hydrogen fuel delivery assembly being connected to the hydrogen fuel tank, and a vaporizer in communication with the hydrogen fuel delivery assembly for heating the hydrogen fuel in the liquid phase to at least one of a gaseous phase and a supercritical phase, the vaporizer being located between the hydrogen fuel tank and the combustor.

An aircraft including a fuselage, a wing connected to the fuselage, and the gas turbine engine of any preceding clause.

The aircraft of the preceding clause, wherein the hydrogen fuel tank is positioned at least partially within at least one of the fuselage and the wing, and wherein the vaporizer is positioned at least partially within at least one of the fuselage, the wing, and the gas turbine engine.

A gas turbine engine including a hydrogen fuel delivery assembly configured to deliver a hydrogen fuel flow, a compressor section configured to compress air flowing therethrough to provide a compressed air flow, and a combustor including a combustion chamber characterized by a combustor size rating between one inch and seven inches at a core air flow parameter between two and one half kN and sixty kN, wherein the combustor size rating is a function of the core air flow parameter.

The gas turbine engine of any preceding clause, wherein the core air flow parameter is a relationship between the thrust and bypass ratio.

The gas turbine engine of any preceding clause, wherein the combustor size rating is between two inches and three and one quarter inches at a core air flow parameter between two and one half kN and fifty kN.

The gas turbine engine of any preceding clause, wherein the combustor size rating is based on a thrust of the gas turbine engine.

The gas turbine engine of any preceding clause, wherein the thrust is between sixty kN and five hundred kN.

The gas turbine engine of any preceding clause, wherein the combustor size rating is defined by a relationship of the burner length, squared, and the burner dome height.

The gas turbine engine of any preceding clause, further comprising a turbine nozzle downstream of the combustion chamber, wherein the burner length is the distance between a plane orthogonal to a forward line at which the burner dome height is measured and a leading edge of the turbine nozzle.

The gas turbine engine of any preceding clause, wherein the burner length, squared, is between six square inches and thirty-five square inches.

The gas turbine engine of any preceding clause, wherein the combustor further includes an outer liner and an inner liner, the combustion chamber having a forward end and being defined between the outer liner and the inner liner, each of the outer liner and the inner liner having an inner surface, and wherein the burner dome height is the maximum height between the inner surface of the outer liner and the inner surface of the inner liner at the forward end of the combustion chamber.

The gas turbine engine of any preceding clause, wherein the combustor size rating is between two inches and seven inches.

The gas turbine engine of any preceding clause, wherein the combustor size rating is between two inches and six inches.

The gas turbine engine of any preceding clause, wherein the combustor size rating is between three inches and six inches.

The gas turbine engine of any preceding clause, wherein the burner length is between two inches and six inches.

The gas turbine engine of any preceding clause, wherein the burner length is between two inches and three inches.

The gas turbine engine of any preceding clause, wherein the burner length is between two and one half inches and three and one half inches.

The gas turbine engine of any preceding clause, wherein the burner dome height is between two and one half inches and six inches.

The gas turbine engine of any preceding clause, wherein the burner dome height is between two and one half inches and five inches.

The gas turbine engine of any preceding clause, wherein the burner dome height is between four inches and five inches.

The gas turbine engine of any preceding clause, wherein the burner length, squared, is between six square inches and twenty square inches.

The gas turbine engine of any preceding clause, wherein the burner length, squared, is between six square inches and twelve square inches.

The gas turbine engine of any preceding clause, wherein the burner length, squared, is between eight square inches and twelve square inches.

The gas turbine engine of any preceding clause, wherein no diluent is added to the combustion chamber.

The gas turbine engine of any preceding clause, further comprising one or more rotating blades.

The gas turbine engine of any preceding clause, further comprising one or more stationary vanes, wherein the one or more stationary vanes are positioned forward of the rotating blades.

The gas turbine engine of any preceding clause, further comprising one or more stationary vanes, wherein the one or more stationary vanes are positioned aft of the rotating blades.

The gas turbine engine of any preceding clause, further comprising a first set of one or more rotating blades and a second set of rotating blades, the first set of rotating blades and the second set of rotating blades being configured to operate in a counter-rotating fashion.

The gas turbine engine of any preceding clause, further comprising a plurality of fan blades located forward of the combustor in a puller configuration.

The gas turbine engine of any preceding clause, further comprising a plurality of fan blades, the combustor located forward of the plurality of fan blades in a pusher configuration.

The gas turbine engine of any preceding clause, wherein the gas turbine engine is one of a turbofan engine, an unducted single fan engine, a turbojet engine, a turboshaft engine, or a turboprop engine.

The gas turbine engine of any preceding clause, wherein the gas turbine engine is a turbofan engine comprising an outer nacelle that houses the compressor section, the combustor, and a plurality of fan blades.

The gas turbine engine of any preceding clause, wherein the gas turbine engine is an unducted single fan engine comprising a spinner coupled to a nacelle, the nacelle housing the compressor section and the combustor, a plurality of outlet guide vanes coupled to an outer surface of the nacelle, and a plurality of fan blades coupled to the spinner and rotatable therewith.

The gas turbine engine of any preceding clause, wherein the gas turbine engine is a turbojet engine comprising an outer nacelle that houses the compressor section and the combustor, the turbojet engine not including a fan with bypass duct.

The gas turbine engine of any preceding clause, further including a hydrogen fuel tank for holding the hydrogen fuel in a liquid phase, the hydrogen fuel delivery assembly being connected to the hydrogen fuel tank, and a vaporizer in communication with the hydrogen fuel delivery assembly for heating the hydrogen fuel in the liquid phase to at least one of a gaseous phase and a supercritical phase, the vaporizer being located between the hydrogen fuel tank and the combustor.

An aircraft including a fuselage, a wing connected to the fuselage, and the gas turbine engine of any preceding clause.

The aircraft of the preceding clause, wherein the hydrogen fuel tank is positioned at least partially within at least one of the fuselage and the wing, and wherein the vaporizer is positioned at least partially within at least one of the fuselage, the wing, and the gas turbine engine.

A gas turbine engine includes a hydrogen fuel delivery assembly configured to deliver a hydrogen fuel flow, a compressor section configured to compress air flowing therethrough to provide a compressed air flow, and a combustor section having a combustor with a combustor liner, a dome wall coupled to the combustor liner, and a dome inlet located in the dome wall and a combustion chamber defined at least in part by the combustor liner and the dome wall, the combustion chamber characterized by a combustor size rating between one inch and seven inches at a core air flow parameter between two and one half kN and sixty kN, wherein the combustor size rating is a function of the core air flow parameter, and wherein the combustor size rating is defined by a relationship of the burner length, squared, and the burner dome height and wherein the core air flow parameter is a relationship between the thrust and bypass ratio, comprising a combustor liner, and a fuel injector fluidly coupled to the combustion chamber, and at least one set of dilution openings located in the dome wall and fluidly coupled to the combustion chamber.

The gas turbine engine of any preceding clause, wherein the at least one set of dilution openings circumferentially arranged about an engine centerline.

The gas turbine engine of any preceding clause, wherein the at least one set of dilution openings is a first set of dilution openings and a second set of dilution openings concentric with respect to each other.

The gas turbine engine of any preceding clause, wherein at least one of the first and second set of dilution openings are annular dilution openings.

The gas turbine engine of any preceding clause, wherein at least one of the first and second set of dilution openings are segmented dilution openings.

The gas turbine engine of any preceding clause, wherein the at least one set of dilution openings extends between a dilution inlet and a dilution outlet at the dome wall.

The gas turbine engine of any preceding clause, further comprising at least one vane disposed within the at least one set of dilution openings between the dilution inlet and the dilution outlet.

The gas turbine engine of any preceding clause, wherein the at least one vane is one of a radial flow vane or an axial flow vane.

The gas turbine engine of any preceding clause, wherein the dome inlet defines a dome centerline and the at least one set of dilution openings defines a dilution centerline.

The gas turbine engine of any preceding clause, wherein the dilution centerline is a first centerline angled toward the longitudinal axis and intersecting with the dome centerline to define a dilution angle.

The gas turbine engine of any preceding clause, wherein the dome wall defines a conic portion forming an obtuse angle with the combustor liner and the dome wall extends radially between the fuel injector and the combustor liner to define a flat portion, wherein the flat portion and the conic portion meet at a first junction.

The gas turbine engine of any preceding clause, wherein the at least one set of dilution openings is located in the conic portion.

The gas turbine engine of any preceding clause, wherein the conic portion extends between the first junction and the combustor liner.

The gas turbine engine of any preceding clause, wherein the at least one set of dilution openings is located in the flat portion.

The gas turbine engine of any preceding clause, wherein the flat portion extends between the first junction and the combustor liner.

The gas turbine engine of any preceding clause, further comprising a flare cone disposed around the fuel injector, wherein the flare cone meets the flat portion at a second junction and wherein the flat portion extends between the first junction and the second junction.

The gas turbine engine of any preceding clause, further comprising a flare cone disposed around the fuel injector, wherein the flare cone meets the conic portion at a second junction and wherein the conic portion extends between the first junction and the second junction.

The gas turbine engine of any preceding clause, further comprising a flare cone disposed around the fuel injector and a purge passage disposed around the flare cone.

The gas turbine engine of any preceding clause, further comprising at least one axial deflector.

The gas turbine engine of any preceding clause, wherein the dome wall comprises a deflector and an impingement wall spaced apart to define an intermediate plenum.

The gas turbine engine of any preceding clause, wherein the at least one set of dilution openings are circumferentially disposed about the dome inlet.

The gas turbine engine of any preceding clause, wherein the combustor size rating is between two inches and three and one quarter inches at a core air flow parameter between two and one half kN and fifty kN.

The gas turbine engine of any preceding clause, wherein the combustor size rating is based on a thrust of the gas turbine engine.

The gas turbine engine of any preceding clause, wherein the thrust is between sixty kN and five hundred kN.

The gas turbine engine of any preceding clause, further including a turbine nozzle downstream of the combustion chamber, wherein the burner length is the distance between a plane orthogonal to a forward line at which the burner dome height is measured and a leading edge of the turbine nozzle.

The gas turbine engine of any preceding clause, wherein the burner length, squared, is between six square inches and thirty-five square inches.

The gas turbine engine of any preceding clause, wherein the combustor further includes an outer liner and an inner liner, the combustion chamber having a forward end and being defined between the outer liner and the inner liner, each of the outer liner and the inner liner having an inner surface, and wherein the burner dome height is the maximum height between the inner surface of the outer liner and the inner surface of the inner liner at the forward end of the combustion chamber.

The gas turbine engine of any preceding clause, wherein the combustor size rating is between two inches and seven inches.

The gas turbine engine of any preceding clause, wherein the combustor size rating is between two inches and six inches.

The gas turbine engine of any preceding clause, wherein the combustor size rating is between three inches and six inches.

The gas turbine engine of any preceding clause, wherein the burner length is between two inches and six inches.

The gas turbine engine of any preceding clause, wherein the burner length is between two inches and three inches.

The gas turbine engine of any preceding clause, wherein the burner length is between two and one half inches and three and one half inches.

The gas turbine engine of any preceding clause, wherein the burner dome height is between two and one half inches and six inches.

The gas turbine engine of any preceding clause, wherein the burner dome height is between two and one half inches and five inches.

The gas turbine engine of any preceding clause, wherein the burner dome height is between four inches and five inches.

The gas turbine engine of any preceding clause, wherein the burner length, squared, is between six square inches and twenty square inches.

The gas turbine engine of any preceding clause, wherein the burner length, squared, is between six square inches and twelve square inches.

The gas turbine engine of any preceding clause, wherein the burner length, squared, is between eight square inches and twelve square inches.

The gas turbine engine of any preceding clause, wherein no diluent is added to the combustion chamber.

The gas turbine engine of any preceding clause, further including one or more rotating blades.

The gas turbine engine of any preceding clause, further including one or more stationary vanes, wherein the one or more stationary vanes are positioned forward of the rotating blades.

The gas turbine engine of any preceding clause, further including one or more stationary vanes, wherein the one or more stationary vanes are positioned aft of the rotating blades.

The gas turbine engine of any preceding clause, further including a first set of one or more rotating blades and a second set of rotating blades, the first set of rotating blades and the second set of rotating blades being configured to operate in a counter-rotating fashion.

The gas turbine engine of any preceding clause, further including a plurality of fan blades located forward of the combustor in a puller configuration.

The gas turbine engine of any preceding clause, further including a plurality of fan blades, the combustor located forward of the plurality of fan blades in a pusher configuration.

The gas turbine engine of any preceding clause, wherein the gas turbine engine is one of a turbofan engine, an unducted single fan engine, a turbojet engine, a turboshaft engine, or a turboprop engine.

The gas turbine engine of any preceding clause, wherein the gas turbine engine is a turbofan engine including an outer nacelle that houses the compressor section, the combustor, and a plurality of fan blades.

The gas turbine engine of any preceding clause, wherein the gas turbine engine is an unducted single fan engine including a spinner coupled to a nacelle, the nacelle housing the compressor section and the combustor, a plurality of outlet guide vanes coupled to an outer surface of the nacelle, and a plurality of fan blades coupled to the spinner and rotatable therewith.

The gas turbine engine of any preceding clause, wherein the gas turbine engine is a turbojet engine including an outer nacelle that houses the compressor section and the combustor, the turbojet engine not including a fan with bypass duct.

The gas turbine engine of any preceding clause, further including a hydrogen fuel tank for holding the hydrogen fuel in a liquid phase, the hydrogen fuel delivery assembly being connected to the hydrogen fuel tank, and a vaporizer in communication with the hydrogen fuel delivery assembly for heating the hydrogen fuel in the liquid phase to at least one of a gaseous phase and a supercritical phase, the vaporizer being located between the hydrogen fuel tank and the combustor.

An aircraft including a fuselage, a wing connected to the fuselage, and the gas turbine engine of any preceding clause.

The aircraft of the preceding clause, wherein the hydrogen fuel tank is positioned at least partially within at least one of the fuselage and the wing, and wherein the vaporizer is positioned at least partially within at least one of the fuselage, the wing, and the gas turbine engine.

Although the foregoing description is directed to the preferred embodiments, it is noted that other variations and modifications will be apparent to those skilled in the art, and may be made without departing from the spirit or scope of the disclosure Moreover, features described in connection with one embodiment may be used in conjunction with other embodiments, even if not explicitly stated above.

What is claimed is:

1. A gas turbine engine comprising:
a hydrogen fuel delivery assembly configured to deliver a hydrogen fuel flow;
a compressor section configured to compress air flowing therethrough to provide a compressed air flow; and
a combustion section comprising a fuel injector and a combustor having a combustor liner and a dome wall, including a combustion chamber defined at least in part by the combustor liner and dome wall and characterized by a combustor size rating between one inch and seven inches at a core air flow parameter between two and one half kN and sixty kN, wherein the combustor size rating is a function of the core air flow parameter, and
wherein the combustor size rating is defined by:
$$\frac{{L}^{2}}{H}$$
and, wherein the core air flow parameter is defined by:
$$\frac{Thrust}{Bypass Ratio}$$
and, at least one set of dilution openings located in the dome wall and fluidly coupled to the combustion chamber.

2. The gas turbine engine of claim 1, wherein the at least one set of dilution openings are circumferentially arranged about an engine centerline.

3. The gas turbine engine of claim 2, wherein the at least one set of dilution openings is a first set of dilution openings and a second set of dilution openings concentric with respect to each other.

4. The gas turbine engine of claim 3, wherein at least one of the first set of dilution openings or the second set of dilution openings are annular dilution openings.

5. The gas turbine engine of claim 3, wherein at least one of the first set of dilution openings or the second set of dilution openings are segmented dilution openings.

6. The gas turbine engine of claim 1, wherein the at least one set of dilution openings extends between a dilution inlet and a dilution outlet at the dome wall.

7. The gas turbine engine of claim 6, further comprising at least one vane disposed within the at least one set of dilution openings between the dilution inlet and the dilution outlet.

8. The gas turbine engine of claim 7, wherein the at least one vane is one of a radial flow vane or an axial flow vane.

9. The gas turbine engine of claim 1, wherein the dome inlet defines a dome centerline and the at least one set of dilution openings defines a dilution centerline and wherein the dilution centerline is a first centerline angled toward a longitudinal axis and intersecting with the dome centerline to define a dilution angle.

10. The gas turbine engine of claim 1, wherein the dome wall defines a conic portion forming an obtuse angle with the combustor liner and the dome wall extends radially between the fuel injector and the combustor liner to define a flat portion, wherein the flat portion and the conic portion meet at a first junction.

11. The gas turbine engine of claim 10, wherein the at least one set of dilution openings is located in the conic portion or the flat portion.

12. The gas turbine engine of claim 11, wherein the conic portion extends between the first junction and the combustor liner or the flat portion extends between the first junction and the combustor liner.

13. The gas turbine engine of claim 1, further comprising a flare cone disposed around the fuel injector and a purge passage disposed around the flare cone.

14. The gas turbine engine of claim 1, further comprising at least one axial deflector.

15. The gas turbine engine of claim 1, wherein the dome wall comprises a deflector and an impingement wall spaced apart to define an intermediate plenum.

16. The gas turbine engine of claim 1, wherein the at least one set of dilution openings are circumferentially disposed about the dome inlet.

17. The gas turbine engine of claim 1, wherein the combustor size rating is between two inches and three and one quarter inches at a core air flow parameter between two and one half kN and fifty kN.

18. The gas turbine engine of claim 1, wherein the combustor size rating is based on a thrust of the gas turbine engine.

19. The gas turbine engine of claim 18, wherein the thrust is between sixty kN and five hundred kN.

20. The gas turbine engine of claim 1, further comprising a turbine nozzle downstream of the combustion chamber, wherein the burner length is the distance between a plane orthogonal to a forward line at which the burner dome height is measured and a leading edge of the turbine nozzle.
